(19) United States
(12) Patent Application Publication
(10) Pub. No.: US 2016/0379136 A1
(43) Pub. Date: Dec. 29, 2016

(54) Methods and Systems for Automatic Extraction of Behavioral Features from Mobile Applications

(71) Applicant: QUALCOMM Incorporated, San Diego, CA (US)

(72) Inventors: Yin Chen, Campbell, CA (US); Vinay Sridhara, Santa Clara, CA (US); Mihai Christodorescu, San Jose, CA (US)

(21) Appl. No.: 14/751,572

(22) Filed: Jun. 26, 2015

(51) Int. Cl. G06N 99/00

(52) U.S. Cl. CPC G06N 99/005

(57) ABSTRACT

An aspect computing device may be configured to perform program analysis operation in response to classifying a behavior as non-benign. The program analysis operation may identify new sequences of API calls or activity patterns that are associated with the identified non-benign behaviors. The computing device may learn new behavior features based on the program analysis operation or update existing behavior features based on the program analysis operation. For example, API sequences observed to occur when a non-benign behavior is recognized may be added to behavior features observed during program analysis operation.

### BACKGROUND

Cellular and wireless communication technologies have seen explosive growth over the past several years. This growth has been fueled by better communications and hardware, larger networks, and more reliable protocols. As a result, wireless service providers are now able to offer their customers with unprecedented levels of access to information, resources, and communications. To keep pace with these enhancements, consumer electronic devices (e.g., cellular phones, watches, headphones, remote controls, etc.) have become more powerful and complex than ever, and now commonly include powerful processors, large memories, and other resources that allow for executing complex and powerful software applications on their devices. These devices also enable their users to download and execute a variety of software applications from application download services (e.g., Apple® App Store, Windows® Store, Google® play, etc.) or the Internet.

Due to these and other improvements, an increasing number of mobile and wireless device users now use their devices to store sensitive information (e.g., credit card information, contacts, etc.) and/or to accomplish tasks for which security is important. For example, mobile device users frequently use their devices to purchase goods, send and receive sensitive communications, pay bills, manage bank accounts, and conduct other sensitive transactions. Due to these trends, mobile devices are quickly becoming the next frontier for malware and cyber attacks. Accordingly, new and improved security solutions that better identify and respond to malware and other non-benign device behaviors in resource-constrained computing devices, such as mobile and wireless devices, will be beneficial to consumers.

### SUMMARY

The various aspects include methods of analyzing behaviors of a computing device, which may include performing a behavior-based operation, performing a program analysis operation in response to determining that a software application is non-benign based on the behavior-based operation, and updating behavior features used to perform the behavior-based operation based on the program analysis operation or based on the results generated via the performance of one or more program analysis operations. In an aspect, updating the behavior features used to perform the behavior-based operation based on the program analysis operation may include generating a new behavior feature based on the program analysis operation. In a further aspect, updating the behavior features used to perform the behavior-based operation based on the program analysis operation may include updating an application programming interface (API)-to-feature mapping of an existing behavior feature based on the program analysis operation. In a further aspect, performing the program analysis operation in response to determining that the software application is non-benign may include identifying all application programming interface (API) calls that are associated with the software application, generating a list that includes the identified API calls, filtering the list to remove API calls that are associated with known benign applications, and identifying API call sequences based on the API calls included in the filtered list.

In an aspect, performing the program analysis operation in response to determining that the software application is non-benign may further include identifying a correlation between an identified API call sequence and an existing behavior feature, identifying an additional API call sequence based on the identified correlation, and updating an API-to-feature mapping of the existing behavior feature to include the additional API call sequence. In an aspect, performing the program analysis operation in response to determining that the software application is non-benign may further include determining whether any of the identified API call sequences occur frequently, and generating a new behavior feature for each of the identified API call sequences that are determined to occur frequently.

In a further aspect, performing the behavior-based operation may include monitoring activities of the software application operating on the computing device, generating a behavior vector information structure that characterizes monitored activities of the software application, applying the generated behavior vector information structure to machine-learning classifier model to generate analysis results, and using the analysis results to classify the behavior vector information structure as non-benign. In a further aspect, updating the behavior features used to perform the behavior-based operation based on the program analysis operation may include updating an API-to-feature mapping of a behavior feature included in the behavior vector information structure based on a result of the program analysis operation.

In a further aspect, updating the behavior features used to perform the behavior-based operation based on the program analysis operation may include updating a condition evaluated by a decision node in the machine-learning classifier model based on a result of the program analysis operation. In a further aspect, updating the behavior features used to perform the behavior-based operation based on the program analysis operation may include inserting a new behavior feature into the behavior vector information structure based on a result of the program analysis operation. In a further aspect, updating the behavior features used to perform the behavior-based operation based on the program analysis operation may include adding a new decision node to the machine-learning classifier model based on a result of the program analysis operation.

Further aspects may include a computing device that includes means for performing a behavior-based operation, means for performing a program analysis operation in response to determining that a software application is non-benign based on the behavior-based operation, and means for updating behavior features used to perform the behavior-based operation based on the program analysis operation. In an aspect, means for updating behavior features used to perform the behavior-based operation based on the program analysis operation may include means for generating a new behavior feature or updating an application programming interface (API)-to-feature mapping of an existing behavior feature based on the program analysis operation. In a further aspect, means for performing the program analysis operation in response to determining that the software application is non-benign may include means for identifying all application programming interface (API) calls that are associated with the software application, means for generating a list that includes the identified API calls, means for filtering the list to remove API calls that are associated with known benign applications, means for identifying API call sequences based on the API calls included in the filtered list, means for identifying a correlation between an identified API call sequence and an existing behavior feature, means for identifying an additional API call sequence based on the identified correlation, and means for updating an API-to-feature mapping of the existing behavior feature to include the additional API call sequence.

In a further aspect, means for performing the program analysis operation in response to determining that the software application is non-benign may include means for identifying all application programming interface (API) calls that are associated with the software application, means for generating a list that includes the identified API calls, means for filtering the list to remove API calls that are associated with known benign applications, means for identifying API call sequences based on the API calls included in the filtered list, means for determining whether any of the identified API call sequences occur frequently, and means for generating a new behavior feature for each of the identified API call sequences that are determined to occur frequently.

In a further aspect, means for performing the behavior-based operation may include means for monitoring activities of the software application as it operates on the computing device, means for generating a behavior vector information structure that characterizes monitored activities of the software application, means for applying the generated behavior vector information structure to machine-learning classifier model to generate analysis results, and means for using the analysis results to classify the behavior vector information structure as non-benign. In a further aspect, means for updating behavior features used to perform the behavior-based operation based on the program analysis operation may include one of means for updating a API-to-feature mapping of a behavior feature included in a behavior vector information structure based on a result of the program analysis operation, means for updating a condition evaluated by a decision node in a machine-learning classifier model based on the result of the program analysis operation, means for inserting a new behavior feature into the behavior vector information structure based on the result of the program analysis operation, and means for adding a new decision node to the machine-learning classifier model based on the result of the program analysis operation.

Further aspects may include a computing device having a processor configured with processor-executable instructions to perform operations that include performing a behavior-based operation, performing a program analysis operation in response to determining that a software application is non-benign based on the behavior-based operation, and updating behavior features used to perform the behavior-based operation based on the program analysis operation. In an aspect, the processor may be configured with processor-executable instructions to perform operations such that updating the behavior features used to perform the behavior-based operation based on the program analysis operation may include generating a new behavior feature or updating an application programming interface (API)-to-feature mapping of an existing behavior feature based on the program analysis operation.

In a further aspect, the processor may be configured with processor-executable instructions to perform operations such that performing the program analysis operation in response to determining that the software application is non-benign may include identifying all application programming interface (API) calls that are associated with the software application, generating a list that includes the identified API calls, filtering the list to remove API calls that are associated with known benign applications, identifying API call sequences based on the API calls included in the filtered list, identifying a correlation between an identified API call sequence and an existing behavior feature, identifying an additional API call sequence based on the identified correlation, and updating an API-to-feature mapping of the existing behavior feature to include the additional API call sequence.

In a further aspect, the processor may be configured with processor-executable instructions to perform operations such that performing the program analysis operation in response to determining that the software application is non-benign may include identifying all application programming interface (API) calls that are associated with the software application, generating a list that includes the identified API calls, filtering the list to remove API calls that are associated with known benign applications, identifying API call sequences based on the API calls included in the filtered list, determining whether any of the identified API call sequences occur frequently, and generating a new behavior feature for each of the identified API call sequences that are determined to occur frequently.

In a further aspect, the processor may be configured with processor-executable instructions to perform operations such that performing the behavior-based operation may include monitoring activities of the software application as it operates on the computing device, generating a behavior vector information structure that characterizes monitored activities of the software application, applying the generated behavior vector information structure to machine-learning classifier model to generate analysis results, and using the analysis results to classify the behavior vector information structure as non-benign.

In a further aspect, the processor may be configured with processor-executable instructions to perform operations such that updating the behavior features used to perform the behavior-based operation based on the program analysis operation may include performing an update operation selected from the group including updating a API-to-feature mapping of a behavior feature included in a behavior vector information structure based on a result of the program analysis operation, updating a condition evaluated by a decision node in a machine-learning classifier model based on the result of the program analysis operation, inserting a new behavior feature into the behavior vector information structure based on the result of the program analysis operation, and adding a new decision node to the machine-learning classifier model based on the result of the program analysis operation.

Further aspects may include a non-transitory computer readable storage medium having stored thereon processor-executable software instructions configured to cause a processor of a computing device to perform operations including performing a behavior-based operation, performing a program analysis operation in response to determining that a software application is non-benign based on the behavior-based operation, and updating behavior features used to perform the behavior-based operation based on the program analysis operation. In an aspect, the stored processor-executable software instructions may be configured to cause a processor to perform operations such that updating the behavior features used to perform the behavior-based operation based on the program analysis operation may include generating a new behavior feature or updating an application programming interface (API)-to-feature mapping of an existing behavior feature based on the program analysis operation.

In a further aspect, the stored processor-executable software instructions may be configured to cause a processor to perform operations such that performing the program analysis operation in response to determining that the software application is non-benign may include identifying all application programming interface (API) calls that are associated with the software application, generating a list that includes the identified API calls, filtering the list to remove API calls that are associated with known benign applications, and identifying API call sequences based on the API calls included in the filtered list. In a further aspect, the stored processor-executable software instructions may be configured to cause a processor to perform operations such that performing the program analysis operation in response to determining that the software application is non-benign further may include identifying a correlation between an identified API call sequence and an existing behavior feature, identifying an additional API call sequence based on the identified correlation, and updating an API-to-feature mapping of the existing behavior feature to include the additional API call sequence.

In a further aspect, the stored processor-executable software instructions may be configured to cause a processor to perform operations such that performing the program analysis operation in response to determining that the software application is non-benign further includes determining whether any of the identified API call sequences occur frequently, and generating a new behavior feature for each of the identified API call sequences that are determined to occur frequently. In a further aspect, the stored processor-executable software instructions may be configured to cause a processor to perform operations such that performing the behavior-based operation includes monitoring activities of the software application as it operates on the computing device, generating a behavior vector information structure that characterizes monitored activities of the software application, applying the generated behavior vector information structure to machine-learning classifier model to generate analysis results, and using the analysis results to classify the behavior vector information structure as non-benign.

In a further aspect, the stored processor-executable software instructions may be configured to cause a processor to perform operations such that updating the behavior features used to perform the behavior-based operation based on the program analysis operation includes performing an update operation selected from the group including updating a API-to-feature mapping of a behavior feature included in a behavior vector information structure based on a result of the program analysis operation, updating a condition evaluated by a decision node in a machine-learning classifier model based on the result of the program analysis operation, inserting a new behavior feature into the behavior vector information structure based on the result of the program analysis operation, and adding a new decision node to the machine-learning classifier model based on the result of the program analysis operation.

### BRIEF DESCRIPTION OF THE DRAWINGS

The accompanying drawings, which are incorporated herein and constitute part of this specification, illustrate exemplary aspects of the claims, and together with the general description given above and the detailed description given below, serve to explain the features of the claims.

FIG. 1 is a block diagram illustrating components of an example system on chip that may be included in an aspect computing device and configured to generate or update behavior features in accordance with the various aspects.

FIG. 2 is a block diagram illustrating example logical components and information flows in an aspect mobile device configured to use machine learning and behavior-based techniques to classify behaviors in accordance with the various aspects.

FIG. 3A is a process flow diagram illustrating a method of updating or enhancing existing behavior features in accordance with an aspect.

FIG. 3B is a process flow diagram illustrating a method of learning and generating new behavior features in accordance with an aspect.

FIG. 4 is a process flow diagram illustrating another aspect mobile device method of generating lean classifier models in the mobile device.

FIG. 5 is an illustration of example decision nodes that may be generated and used to generate lean classifier models in accordance with an aspect.

FIG. 6 is a process flow diagram illustrating a method for performing adaptive observations in a computing device in accordance with an aspect.

FIG. 7 is a component block diagram of a mobile device suitable for use in an aspect.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

In overview, the various aspects include methods, and computing devices configured to implement the methods, of using behavior-based and machine learning techniques to efficiently identify, classify, model, prevent, and/or correct the conditions and behaviors that often degrade a computing device's performance, power utilization levels, network usage levels, security and/or privacy over time. To accomplish this, the computing device may perform real-time behavior monitoring and analysis operations, which may include monitoring activities of one or more software applications operating on the computing device (e.g., by monitoring API calls at the hardware, driver, kernel, NDK, SDK, and/or Webkit levels, etc.), generating behavior vector information structures (herein “behavior vectors”) that characterize all or a subset of the monitored activities of one or more software applications, applying the generated behavior vectors to machine-learning classifier models (herein “classifier models”) to generate analysis results, and using the analysis results to classify the behavior vector (and thus the activities characterized by that vector and/or a software application associated with the monitored activities) as benign or non-benign. The computing device may also be configured to perform program analysis operations in response to determining that the behavior or software application is non-benign, and update one or more of the behavior features that are used to perform the behavior-based operations based on the results of performing the program analysis operations.

The computing device may update the behavior features by generating a new behavior feature (e.g., for inclusion in the behavior vectors or evaluation by the classifier models) or by updating an API-to-feature mapping of an existing behavior feature (e.g., currently included in at least one behavior vector or evaluated by at least one classifier model). In some aspects, the program analysis operations may include analyzing program code to identify all of the API calls that could be made by and/or are otherwise associated with the software application. This analysis may include generating a list that includes the identified API calls, filtering the list by remove API calls that are associated with common operations or software application that are known to be benign, and identifying API call sequences based on the API calls included in the filtered list.

In an aspect, the computing device may be further configured to identify a correlation between an identified API call sequence and an existing behavior feature, identify an behavior-based operation additional API call sequence based on the identified correlation, and update the API-to-feature mapping of the existing behavior feature to include the additional API call sequence. In another aspect, the computing device may be configured to determine the frequency in which the API call sequences occur, and generate a new behavior feature for the API call sequences that occur frequently.

It has been observed that when a computing device detects an activity pattern or a sequence of API calls (e.g., getLocation( ) API 4→sendTo( ) API, etc.) that is known to be associated with a non-benign behavior, there are additional activity patterns or sequences of API calls that are also associated with that same non-benign behavior, but which were not previously known and/or which are not currently associated with that non-benign behavior. As an example, the computing device may be configured to recognize that a first activity pattern (i.e., A→B) is associated with a first non-benign behavior, and detect that a second activity pattern (i.e., C→D→E) occurs each time the first non-benign behavior is identified. However, existing behavior-based solutions do not adequately or dynamically define new behavior features that identify the second activity pattern as being associated with the first non-benign behavior. Existing solutions also do not adequately update their existing behavior features, their API-to-feature mappings, their activity patterns, or how feature values are computed, analyzed or used by the computing device based on the newly identified activity patterns (e.g., the second activity pattern C→D→E). To the contrary, most existing solutions require that the behavior features, their API-to-feature mappings, the activity patterns, etc. be defined statically and in advance, such as by a server computing device that generates a full or robust classifier model that is then sent to the computing device in which it is used.

In view of these observations, an aspect computing device may be configured to perform program analysis operations in response to classifying the behavior vector as non-benign. The program analysis operations may generate results/values that may be used to identify new sequences of API calls or activity patterns that are associated with the identified non-benign behaviors. In some aspects, the computing device may be further configured to learn new behavior features based on the program analysis operations, which may include identifying a sequence of API calls that occurs frequently in association with the non-benign behavior based on the results of the program analysis operations (e.g., based on the program analysis results). The computing device may add new decision nodes to a new or existing classifier model that evaluates/tests a condition or feature that is associated with an identified sequence of API calls. The computing device may also generate a behavior feature that includes a new API-to-feature mapping, a new feature definition, and/or a new feature value that is incremented or updated each time that the computing device detects the identified sequence of API calls.

In some aspects, the computing device may be configured to enhance existing behavior features based on the program analysis operations (e.g., based on the program analysis results), which may include identifying API sequence correlations with existing feature definitions, identifying additional API sequences that should be mapped to existing features, and/or updating existing API-to-feature mappings, activity patterns, feature definitions or how a feature value is computed, updated, or used to characterize an aspect of the computing device's behavior.

In an aspect, the computing device may be configured to update the behavior features used to perform the behavior-based operation by selecting and/or perform one or more update operations. In an aspect, the update operations may include updating a API-to-feature mapping of a behavior feature included in a behavior vector information structure based on a result of the program analysis operation. In an aspect, the update operation may include updating a condition evaluated by a decision node in a machine-learning classifier model based on the result of the program analysis operation. In an aspect, the update operation may include inserting a new behavior feature into the behavior vector information structure based on the result of the program analysis operation. In an aspect, the update operation may include adding a new decision node to the machine-learning classifier model based on the result of the program analysis operation.

The word “exemplary” is used herein to mean “serving as an example, instance, or illustration.” Any implementation described herein as “exemplary” is not necessarily to be construed as preferred or advantageous over other implementations.

The terms “mobile computing device” and “mobile device” are used interchangeably herein to refer to any one or all of cellular telephones, smartphones, personal or mobile multi-media players, personal data assistants (PDA's), laptop computers, tablet computers, smartbooks, ultrabooks, palm-top computers, wireless electronic mail receivers, multimedia Internet enabled cellular telephones, wireless gaming controllers, and similar personal electronic devices which include a memory, a programmable processor for which performance is important, and operate under battery power such that power conservation methods are of benefit. While the various aspects are particularly useful for mobile computing devices, such as smartphones, which have limited resources and run on battery, the aspects are generally useful in any electronic device that includes a processor and executes application programs.

In the various aspects, computing devices may be equipped with a behavioral-based monitoring and analysis system that is configured to perform real-time behavior monitoring and analysis operations. The behavioral-based monitoring and analysis system may include an observer process, daemon, module, or sub-system (herein collectively referred to as a “module”), a behavior extractor module, an analyzer module, and actuator module. The observer module may be configured to instrument or coordinate various application programming interfaces (APIs), registers, counters, or other device components (herein collectively “instrumented components”) at various levels of the computing device system, collect behavior information from the instrumented components, and communicate (e.g., via a memory write operation, function call, etc.) the collected behavior information to the behavior extractor module.

The behavior extractor module may use the collected behavior information to generate behavior vectors that each represent or characterize many or all of the observed behaviors associated with a specific software application, module, component, task, or process of the computing device. The behavior extractor module may communicate (e.g., via a memory write operation, function call, etc.) the behavior vectors to the analyzer module, which may apply the behavior vectors to classifier models to generate analysis results that may be used to determine whether a software application or device behavior is benign or non-benign. The analyzer module may notify the actuator module when it determines with a high degree of confidence (e.g., based on the analysis results, etc.) that a behavior or software application is non-benign. In response, the actuator module may perform various operations to heal, cure, isolate, or otherwise fix the identified problem(s). For example, the actuator module may be configured to quarantine a software application that is determined to be malware, terminate a malicious process, display a prompt requesting that the user select whether to uninstall or whitelist an application determined to be non-benign, notify the user that a software application is contributing to the device's performance degradation over time, etc.

Each behavior vector may encapsulate, include, or represent one or more “behavior features.” Each behavior feature may represent an observed activity/behavior or an aspect of the device's behavior, such as “Location,” “Personal Identifiers,” “International Mobile Station Equipment Identity (IMEI),” “Communications,” and “Short Message Service (SMS).” Each behavior feature may include a feature value, which may be an abstract number or symbol that represents all or a portion of the observed activity/behavior. Each behavior feature may also be associated with a data type that identifies a range of possible values (e.g., a range for the feature value), operations that may be performed on those values, meanings of the values, etc. The data type may be used by the computing device to determine how the behavior feature (or its feature value) should be measured, analyzed, weighted, or used.

In addition, each behavior feature in a behavior vector may be mapped to one or more APIs. As an example, the behavior feature “User Interaction” may include the feature value “amount,” which may be an integer (or a floating point value, double, etc.) that is incremented each time one of the View.onTouchEvent( ), View.onKeyDown, View.onKeyUp, or View.onTrackBallEvent APIs is called or invoked. In other words, the “User Interaction” behavior feature may describe the frequency in which the user interacts with the computing device via its feature value “amount.” To accomplish this, the “User Interaction” behavior feature and/or its feature value is mapped to multiple APIs, including the View.onTouchEvent( ), View.onKeyDown, View.onKeyUp, and View.onTrackBallEvent APIs. Further, since the feature value “amount” is incremented each time any of the mapped APIs is invoked, there is a one-to-one mapping of the behavior feature to each API. Said another way, the behavior feature “User Interaction” includes one-to-one API-to-feature mapping.

A behavior feature may also include a many-to-one API-to-feature mapping. This is because it is common for two or more APIs to be called in sequence or together as part of a more complex operation, and for a feature value to represent such complex operations via a single or unitary value or symbol. For example, the behavior feature “LocationComm” may characterize or represent the behavior of sending location information via its feature value “number of communications,” which may be an integer that is incremented each time the getLocation( ) API is called before (e.g., immediately before, within a certain amount of time before, etc.) the sendTo( ) API. The “number of communications” feature value is incremented as such because individual invocations of the getLocation( ) API or the sendTo( ) API do not indicate or suggest that location information was communicated. Rather, it is the reading of location information (e.g., via the getLocation( ) API) immediately prior to the transmitting the information (e.g., via the sendTo( ) API) that suggests location information was communicated. As a result, the “LocationComm” behavior feature uses a many-to-one API-to-feature mapping (i.e., a two-to-one mapping in this case) to characterize or represent the behavior or operation of sending location information.

As mentioned above, behavior vectors may be applied to classifier models to generate the analysis results that are suitable for use in classifying device behaviors. A classifier model may be a behavior model that includes data and/or information structures (e.g., decision nodes, component lists, etc.) that may be used by the computing device processor to evaluate a specific behavior feature or an aspect of the device's observed behavior. A classifier model may also include decision nodes and/or decision criteria for monitoring or analyzing a number of features, factors, data points, entries, APIs, states, conditions, behaviors, software applications, processes, operations, components, etc. (herein collectively “features”) in the computing device.

Each classifier model may be categorized as a full classifier model or a lean classifier model. A full classifier model may be a robust data model that is generated as a function of a large training dataset, which may include thousands of features and billions of entries. A lean classifier model may be a more focused data model that is generated from a reduced dataset that includes or prioritizes tests on the features/entries that are most relevant for determining whether a particular device behavior is not benign. A locally generated lean classifier model may be a lean classifier model that is generated in the computing device in which it is used.

Each classifier model may include multiple decision nodes (e.g., decision trees, boosted decision stumps, etc.), and each decision node may include a weight value and a test question/condition that is suitable for evaluating a behavior feature. For example, a classifier model may include a decision node (e.g., in the form of decision stump, etc.) that evaluates the condition “is the frequency of SMS communications of location-based information less than X per minute.” In this example, applying behavior vector that includes an “SMS” behavior feature having a feature value of “3” to the classifier model may generate a result that indicates a “yes” answer (for “less than X” SMS transmissions) or a “no” answer (for “X or more” SMS transmissions) via a symbol or a number, such as “1” for “yes” and “0” for “no”.

Since each behavior vector may include multiple behavior features and each classifier model may include multiple decision nodes, applying a behavior vector to a classifier model may generate a plurality of answers to a plurality of different test conditions. Each of these answers may be represented by a numerical value. The computing device may multiply each of these numerical values with their respective weight value to generate a plurality of weighted answers. The computing device may then compute or determine a weighted average based on the weighted answers, and compare the computed weighted average to threshold values, such as an upper threshold and a lower threshold.

The computing device may use the result of these comparisons to determine whether the activities characterized by the behavior vector may be classified as benign or non-benign with a high degree of confidence. For example, if the computed weighted average is “0.95” and an upper threshold value for non-benign applications is “0.80,” the computing device may classify the behavior characterized by the behavior vector as “non-benign” with a high degree of confidence because the computed weighted average exceeds the upper/high threshold value (i.e., “0.95”>“0.80”). Similarly, if the computed weighted average is “0.10” and the lower/low threshold value for non-benign applications is “0.20,” the computing device may classify the behavior vector (and thus the observed behavior) as “benign” with a high degree of confidence because the computed weighted average exceeds the lower or low threshold value (i.e., “0.10”<“0.20”).

The computing device may be configured to determine that a behavior (or behavior vector) is “suspicious” when it cannot classify a behavior with a sufficiently high degree of confidence as being either “benign” or “non-benign,” such as when the value of the computed weighted average is below the high threshold and above the low threshold value. For example, the computing device may determine that a behavior (or behavior vector) is “suspicious” when the computed weighted average is 0.50, the upper threshold value is 0.95, lower threshold value is 0.20. In response to determining that the behavior is suspicious, the computing device may select a stronger (e.g., less lean, more focused, etc.) classifier model and repeat any or all of the above-described operations to generate additional or different analysis results. The computing device may use this new or additional analysis information to determine whether the suspicious behavior (e.g., the behavior vector and/or the activities characterized by the vector) may be classified as either benign or non-benign with a high degree of confidence. If not, the computing device may repeatedly or continuously perform the-above described operations until it determines that the behavior can be classified as benign or non-benign with a high degree of confidence (e.g., until the weighted average is above the high threshold or below the low threshold, etc.), until a processing or battery consumption threshold is reached, or until the computing device determines that the cause or source of the suspicious behavior cannot be identified from the use of stronger classifier models, larger behavior vectors, or changes in observation granularity.

While the above-mentioned system is generally very effective, its performance may be improved by intelligently selecting and/or dynamically generating the classifier models, the behavior features evaluated by the classifier models, and the behavior features that are monitored and included in the behavior vectors. This is because many modern computing devices are highly configurable and complex systems, and the features that are most important for determining whether a particular device behavior is benign or not benign may be different in each device. Further, a different combination of features may require monitoring and/or analysis in each device in order for that device to quickly and efficiently determine whether a particular behavior is benign or not benign.

Many existing behavior-based solutions implement a “one-size-fits-all” approach to modeling the behaviors of a computing device. These solutions typically generate the behavior models so that they are generic and may be used in many computing devices and/or with a variety of different hardware and software configurations. These generic behavior models often include/test a very large number of features, many of which are not relevant to (and thus cannot be used for) identifying, analyzing, or classifying a behavior of the specific computing device in which they are used. Such models are not suitable for use in modern computing devices, such as resource-constrained or mobile devices, because they may cause the device to analyze a large number of features that are not useful for identifying a cause or source of the device's performance degradation over time.

By intelligently selecting and/or dynamically generating the classifier models and/or the behavior features, the various aspects allow a computing device to focus its monitoring and analysis operations on the precise combination of features that are most important to identifying and responding to behaviors that are the cause or source of its degradation in performance over time. This allows the device to continuously or repeatedly monitor and evaluate a large variety of device behaviors without causing a significant negative or user-perceivable change in its responsiveness, performance, or power consumption characteristics. As a result, the various aspects are especially well suitable for inclusion and use in complex-yet-resource-constrained computing systems, such as modern mobile computing devices.

Generally, classifier models are generated by performing feature selection or feature generation operations to identify, define, or determine the test conditions or behavior features that should be evaluated by the decision nodes in the classifier models. In conventional solutions, such feature selection operations often include or require actions or operations that are labor and/or resource intensive (e.g., processor intensive, power intensive, etc.), such as log data analysis, security literature studies, reverse engineering of malware code, etc. For example, many conventional solutions require that a malware expert define feature selection rules that are used by the server computing device to identify, select, or generate the features that are tested or evaluated by the decision nodes in the classifier model. Since these operations are labor and/or resource intensive, existing feature selection operations are commonly performed in powerful server computing devices, and sent to the computing device in which the model is used to classify behaviors. For example, a server computing device may be configured to receive behavior information on various conditions, features, and operations from a central database (e.g., the “cloud”), use the received behavior information in conjunction with static or pre-defined feature selection rules (which are determined by a malware expert in advance) to determine, define, identify or generate the decision nodes that are included in the full classifier model, and send the full classifier model to a client computing device for use in classifying behaviors. However, such models (e.g. full or robust classifier models) may require or cause the client computing device to analyze a large number of features that are not useful for identifying a cause or source of that device's performance degradation over time, and are therefore not suitable for use in computing devices that are resource-constrained and/or for which performance is important.

To improve performance, the computing device (e.g., client computing device) may be configured to receive a full classifier model from a server, and use the full classifier model to locally generate lean classifier models or a family of lean classifier models of varying levels of complexity (or “leanness”). The computing device may use these lean classifier models to evaluate a targeted subset of features included in the full classifier model, such as the features that are determined to be most relevant to classifying behaviors in that specific device. This allows the computing device to focus its monitoring and analysis operations on the precise combination of features that are most important to identifying and responding to non-benign behaviors. This also allows the device to continuously or repeatedly monitor and evaluate a large variety of device behaviors without causing a significant negative or user-perceivable change in its responsiveness, performance, or power consumption characteristics.

In order to generate lean classifier models from the full classifier model received from the server, the computing device (e.g., client computing device) may be configured to perform operations that include feature selection and/or feature generation. However, due to resource constraints, the feature selection and/or feature generation operations performed by the computing device differ from those performed in the more powerful server computing device. For example, the feature selection operations performed by the computing device (e.g., client computing device) typically include the culling of the decision nodes included in a full classifier model (received from the server) to generate a local and lean classifier model that includes a subset of the decision nodes included in the full classifier model and/or that evaluates a limited number of conditions/behaviors that are specific to the specific computing device in which the model is used. These feature selection/generation operations may also include (or may be performed in conjunction with) prioritization operations that organize and/or prioritize the decision nodes in the lean classifier model. For example, in some aspects, the computing device may be configured to identify the behavior features that are most relevant to the device's configuration, functionality or hardware, and assign higher priorities to the decision nodes that test/evaluate the identified behavior features (i.e., the features that are more relevant to that device's configuration, functionality and/or connected/included hardware). In some aspects, the computing device may generate the classifier models so that the decision nodes are ordered or organized based on their relative priorities. That is, in some aspects, the order in which the decision nodes are included in the classifier model may be indicative of their relative priority or importance to classifying a behavior in that device.

In addition to above-mentioned feature selection/generation operations (e.g., culling the decision nodes, etc.), in some aspects, the computing device may be configured to dynamically determine, define, compute, or generate the behavior features that are included in the behavior vectors that are applied to the locally generated lean classifier models. That is, both the behavior features included behavior vectors and the features tested/evaluated by the decision nodes of the classifier model may be selected, defined, or determined dynamically in the computing device in which they are used to classify a behavior. Dynamically selecting, defining, or determining the behavior features further improves the performance and efficiency of the computing device by allow the computing device to adapt to changing conditions and better focus its monitoring and analysis operations on the precise combination of features that are most important to identifying and responding to non-benign behaviors.

It is often challenging to continuously, repeatedly, or dynamically select, define, or determine the precise behavior features (or combination of features) that are most relevant/important to identifying and responding to non-benign behaviors of the computing device in that computing device without causing a significant negative or user-perceivable change in its responsiveness, performance, or power consumption characteristics. For example, the use of existing feature selection/generation solutions may require that the computing device perform a large number of processor or memory intensive operations that have a significant negative impact on the performance and/or power utilization levels of the device. As a result, existing solutions that are suitable for use in resource constrained devices typically limit the feature selection/generation operations that are performed in the computing device to the culling of decision nodes (described above) and/or similar operations that do not have a significant negative user-perceivable impact on the device. While such feature selection/generation operations may improve the overall performance of the behavior-based system (e.g., compared to systems that use full or generic classifier models, etc.), they do not allow the computing device to determine new behavior features and/or API-to-feature mappings, or to sufficiently or adequately select, define, or determine the precise behavior features (or combination of features) that are most relevant/important to identifying and responding to its non-benign behaviors. Rather, these solutions limit the computing device to evaluating a subset of the behavior features identified or included in the full classifier model received from the server computing device.

The various aspects overcome the above-mentioned limitations of existing solutions by configuring the computing devices to intelligently, dynamically, and efficiently define and redefine new and existing classifier models, the behavior features evaluated by the classifier models, the API-to-feature mappings of the classifier models, and the behavior features included in behavior vectors that are applied to the classifier models.

As discussed above, each behavior feature may be mapped to one or more APIs, invocations of the mapped APIs may be used to compute the feature value associated with the behavior feature, and the value or quantity of the feature value may be used to evaluate an aspect of the device's behavior (e.g., frequency in which location information was accessed, number of SMS messages sent, etc.). As also discussed above, some behavior features may include a many-to-one API-to-feature mapping that is used to characterize, represent, or identify an activity pattern or more complex aspects of the device's behavior. For example, “sending location information” may be represented by incrementing a feature value (e.g., “number of location communications,” etc.) each time the getLocation( ) API is called immediately before the sendTo( ) API, and the computing device may use the feature value (e.g., number of times location information was communicated, etc.) to determine whether a device behavior is non-benign.

It has been observed that when a computing device detects an activity pattern or a sequence of API calls (e.g., getLocation( ) API→sendTo( ) API, etc.) that is known to be associated with a non-benign behavior, there are additional activity patterns or sequences of API calls that are also associated with that same non-benign behavior, but which were not previously known and/or which are not currently associated with that non-benign behavior. As an example, the computing device may be configured to recognize that a first activity pattern (i.e., A→B) is associated with a first non-benign behavior, and detect that a second activity pattern (i.e., C→D→E) occurs each time the first non-benign behavior is identified. However, due to the above-described limitations conventional solutions, existing solutions do not adequately define new behavior features that identify the second activity pattern as being associated with the first non-benign behavior. For these same reasons, existing solutions also do not adequately update their existing behavior features, their API-to-feature mappings or activity patterns, or how feature values are computed, analyzed or used by the computing device based on the newly identified activity patterns (e.g., the second activity pattern C→D→E). To the contrary, most existing solutions require that the behavior features, their API-to-feature mappings, the activity patterns, etc. be defined statically and in advance, such as by the server that generates the full classifier model.

In the various aspects, the computing device may be configured to overcome the above-described limitations of existing solutions by performing behavior-based and/or program analysis operations in response to detecting a non-benign behavior. For example, the detection of the non-benign behavior triggers the system to perform program analysis operations, which may include analyzing the source code, program code, object code, and/or operations of a software application determined to be associated with a non-benign behavior to identify new sequences of API calls (or activity patterns, behavior features, API-to-feature mappings, etc.) that are associated with the software application or non-benign behavior. In response to identifying the new sequences of API calls (or activity patterns, behavior features, API-to-feature mappings, etc.), the computing device may determine the relative importance or the confidence with which each of the newly identified sequences may be used to identify or detect the non-benign behavior. The computing device may filter out the APIs or sequences of API calls that are known to occur frequently, are associated with benign behaviors, that are determined to be of low importance for identifying or detecting that non-benign behavior, etc.

In various aspects, the computing device may be configured to learn new behavior features and/or enhance existing behavior features based on the identified and filtered sequences of API calls. The computing device may be configured to learn new behavior features by identifying a sequence of API calls that occurs frequently and in association with the non-benign behavior, adding a decision node that evaluates/tests a condition or feature that is associated with an identified sequence of API calls to a new or existing classifier model, generating a behavior feature that includes a new API-to-feature mapping and/or a new feature value that is incremented or updated each time the sequence of API calls is detected, or performing other similar operations. The computing device may be configured to enhance existing behavior features by identifying correlations of API sequences with existing feature definitions, identify additional APIs sequences that should be mapped to existing features, and/or updating existing API-to-feature mappings, activity patterns, or how the feature value is computed, updated, or used to characterize an aspect of the device's behavior.

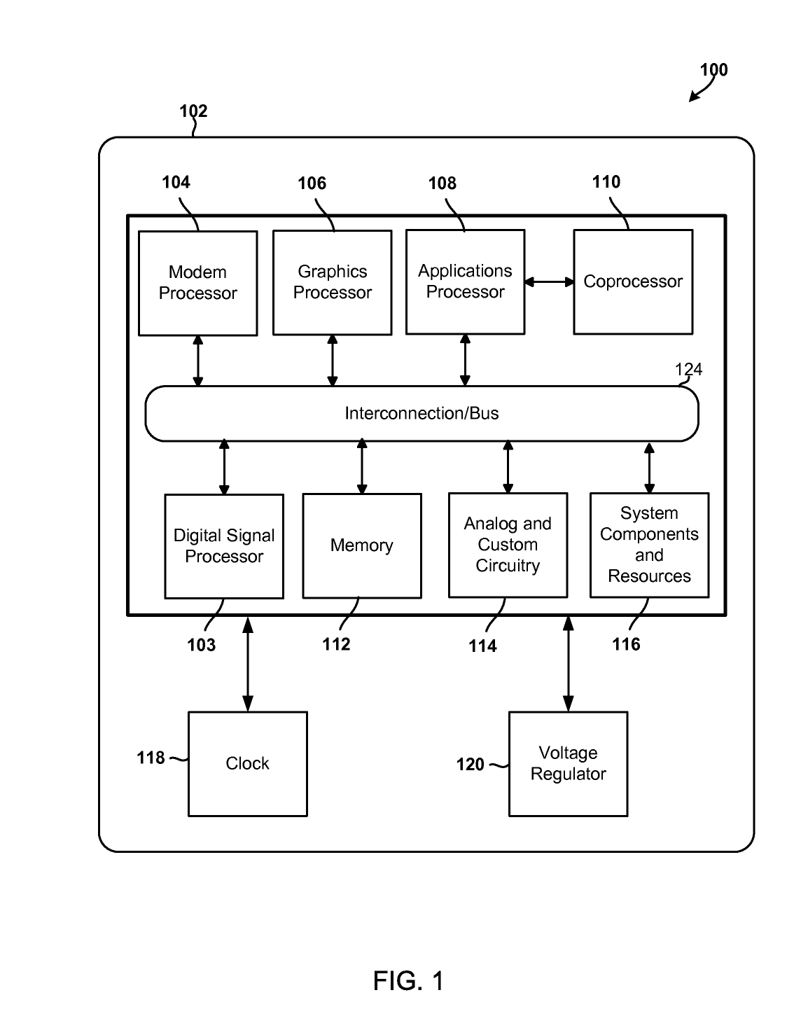

The various aspects may be implemented on a number of single processor and multiprocessor computer systems, including a system-on-chip (SOC). FIG. 1 illustrates an example system-on-chip (SOC) 100 architecture that may be used in computing devices implementing the various aspects. The SOC 100 may include a number of heterogeneous processors, such as a digital signal processor (DSP) 103, a modem processor 104, a graphics processor 106, and an application processor 108. The SOC 100 may also include one or more coprocessors 110 (e.g., vector co-processor) connected to one or more of the heterogeneous processors 103, 104, 106, 108. Each processor 103, 104, 106, 108, 110 may include one or more cores, and each processor/core may perform operations independent of the other processors/cores. For example, the SOC 100 may include a processor that executes a first type of operating system (e.g., FreeBSD, LINUX, OS X, etc.) and a processor that executes a second type of operating system (e.g., Microsoft Windows 8).

The SOC 100 may also include analog circuitry and custom circuitry 114 for managing sensor data, analog-to-digital conversions, wireless data transmissions, and for performing other specialized operations, such as processing encoded audio and video signals for rendering in a web browser. The SOC 100 may further include system components and resources 116, such as voltage regulators, oscillators, phase-locked loops, peripheral bridges, data controllers, memory controllers, system controllers, access ports, timers, and other similar components used to support the processors and software clients (e.g., a web browser) running on a computing device.

The system components and resources 116 and/or custom circuitry 114 may include circuitry to interface with peripheral devices, such as cameras, electronic displays, wireless communication devices, external memory chips, etc. The processors 103, 104, 106, 108 may be interconnected to one or more memory elements 112, system components and resources 116, and custom circuitry 114 via an interconnection/bus module 124, which may include an array of reconfigurable logic gates and/or implement a bus architecture (e.g., CoreConnect, AMBA, etc.). Communications may be provided by advanced interconnects, such as high performance networks-on chip (NoCs).

The SOC 100 may further include an input/output module (not illustrated) for communicating with resources external to the SOC, such as a clock 118 and a voltage regulator 120. Resources external to the SOC (e.g., clock 118, voltage regulator 120) may be shared by two or more of the internal SOC processors/cores (e.g., a DSP 103, a modem processor 104, a graphics processor 106, an applications processor 108, etc.).

In an aspect, the SOC 100 may be included in a mobile device 102, such as a smartphone. The mobile device 102 may include communication links for communication with a telephone network, the Internet, and/or a network server. Communication between the mobile device 102 and the network server may be achieved through the telephone network, the Internet, private network, or any combination thereof.

In various aspects, the SOC 100 may be configured to collect behavioral, state, classification, modeling, success rate, and/or statistical information in the mobile device, and send the collected information to the network server (e.g., via the telephone network) for analysis. The network server may use information received from the mobile device to generate, update or refine classifiers or data/behavior models that are suitable for use by the SOC 100 when identifying and/or classifying performance-degrading mobile device behaviors. The network server may send data/behavior models to the SOC 100, which may receive and use data/behavior models to identify suspicious or performance-degrading mobile device behaviors, software applications, processes, etc.

The SOC 100 may also include hardware and/or software components suitable for collecting sensor data from sensors, including speakers, user interface elements (e.g., input buttons, touch screen display, etc.), microphone arrays, sensors for monitoring physical conditions (e.g., location, direction, motion, orientation, vibration, pressure, etc.), cameras, compasses, GPS receivers, communications circuitry (e.g., Bluetooth®, WLAN, WiFi, etc.), and other well-known components (e.g., accelerometer, etc.) of modern electronic devices.

In addition to the mobile device 102 and SOC 100 discussed above, the various aspects may be implemented in a wide variety of computing systems, which may include a single processor, multiple processors, multicore processors, or any combination thereof.

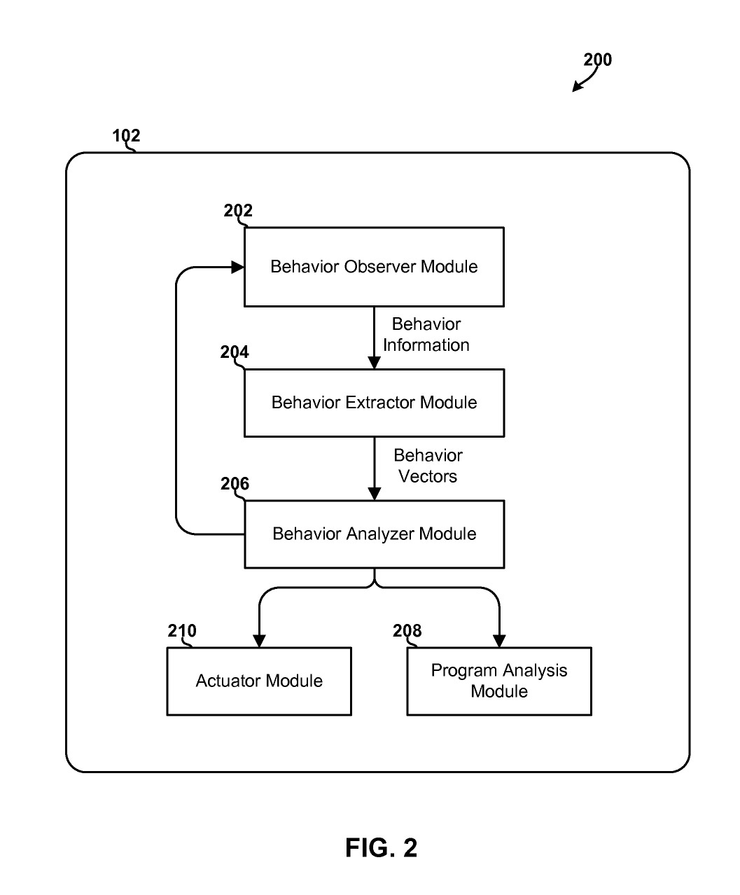

FIG. 2 illustrates example logical components and information flows in an aspect computing device that includes a behavior-based security system 200 configured to use behavioral analysis techniques to identify and respond to non-benign device behaviors. In the example illustrated in FIG. 2, the computing device is a mobile computing device 102 that includes a device processor (i.e., mobile device processor) configured with executable instruction modules that include a behavior observer module 202, a behavior extractor module 204, a behavior analyzer module 206, a program analysis module 208, and an actuator module 210. Each of the modules 202-210 may be a thread, process, daemon, module, sub-system, or component that is implemented in software, hardware, or a combination thereof. In various aspects, the modules 202-210 may be implemented within parts of the operating system (e.g., within the kernel, in the kernel space, in the user space, etc.), within separate programs or applications, in specialized hardware buffers or processors, or any combination thereof. In an aspect, one or more of the modules 202-210 may be implemented as software instructions executing on one or more processors of the mobile computing device 102.

The behavior observer module 202 may be configured to instrument application programming interfaces (APIs), counters, hardware monitors, etc. at various levels/modules of the device, and monitor the activities, conditions, operations, and events (e.g., system events, state changes, etc.) at the various levels/modules over a period of time. For example, the behavior observer module 202 may be configured to monitor various software and hardware components of the mobile computing device 102, and collect behavior information pertaining to the interactions, communications, transactions, events, or operations of the monitored and measurable components that are associated with the activities of the mobile computing device 102. Such activities include a software application's use of a hardware component, performance of an operation or task, a software application's execution in a processing core of the mobile computing device 102, the execution of process, the performance of a task or operation, a device behavior, etc.

The behavior observer module 202 may collect behavior information pertaining to the monitored activities, conditions, operations, or events, and store the collected information in a memory (e.g., in a log file, etc.). The behavior observer module 202 may then communicate (e.g., via a memory write operation, function call, etc.) the collected behavior information to the behavior extractor module 204. The behavior extractor module 204 may be configured to receive or retrieve the collected behavior information, and use this information to generate one or more behavior vectors.

In the various aspects, the behavior extractor module 204 may be configured to generate the behavior vectors to include a concise definition of the observed behaviors, relationships, or interactions of the software applications. For example, each behavior vector may succinctly describe the collective behavior of the software applications in a value or vector data-structure. The vector data-structure may include series of numbers, each of which signifies a feature or a behavior of the device, such as whether a camera of the computing device is in use (e.g., as zero or one), how much network traffic has been transmitted from or generated by the computing device (e.g., 20 KB/sec, etc.), how many internet messages have been communicated (e.g., number of SMS messages, etc.), and/or any other behavior information collected by the behavior observer module 202. In an aspect, the behavior extractor module 204 may be configured to generate the behavior vectors so that they function as identifiers that enable the computing device system (e.g., the behavior analyzer module 206) to quickly recognize, identify, or analyze the relationships between applications.

The behavior analyzer module 206 may also be configured to apply the behavior vectors to classifier modules to determine whether a device behavior (i.e., the collective activities of two or more software applications operating on the device) is a non-benign behavior that is contributing to (or is likely to contribute to) the device's degradation over time and/or which may otherwise cause problems on the device. The behavior analyzer module 206 may notify the program analysis module 208 and/or the actuator module 210 that an activity or behavior is not benign. In response, the actuator module 210 may perform various actions or operations to heal, cure, isolate, or otherwise fix identified problems. For example, the actuator module 210 may be configured to stop or terminate one or more of the software applications when the result of applying the behavior vector to the classifier model (e.g., by the analyzer module) indicates that the collective behavior of the software applications not benign.

The program analysis module 208 may be configured to intelligently select and/or dynamically generate or update the classifier models and/or the behavior features so as to allow the mobile device 102 to focus its monitoring and analysis operations (e.g., operations performed by modules 202-206, etc.) on the precise combination of features that are most important to identifying and responding to non-benign behaviors. The program analysis module 208 may be configured to analyze the source code, program code, object code, and/or operations of a software application determined to be associated with a non-benign behavior to identify new sequences of API calls (or activity patterns, behavior features, API-to-feature mappings, etc.) that are associated with the software application or non-benign behavior.

In response to identifying the new sequences of API calls (or activity patterns, behavior features, API-to-feature mappings, etc.), the program analysis module 208 may determine the relative importance or the confidence with which each of the newly identified sequences may be used to identify or detect the non-benign behavior. The program analysis module 208 may filter out the APIs or sequences of API calls that are known to occur frequently, are associated with benign behaviors, that are determined to be of low importance for identifying or detecting that non-benign behavior, etc. The program analysis module 208 may learn new behavior features and/or enhance existing behavior features based on the identified and filtered sequences of API calls.

The program analysis module 208 may be configured to learn new behavior features by identifying a sequence of API calls that occurs frequently in association with the non-benign behavior, adding a decision node that evaluates/tests a condition or feature that is associated with an identified sequence of API calls to a new or existing classifier model, generating a behavior feature that includes a new API-to-feature mapping and/or a new feature value that is incremented or updated each time the sequence of API calls is detected, or performing other similar operations.

The program analysis module 208 may be configured to enhance existing behavior features by identifying correlations of API sequences with existing feature definitions, identify additional APIs sequences that should be mapped to existing features, and/or updating existing API-to-feature mappings, activity patterns, or how the feature value is computed, updated or used to characterize an aspect of the device's behavior. The program analysis module 208 may be configured to generate or update the behavior features included in behavior vectors and the features tested/evaluated by the decision nodes of the classifier models. By dynamically selecting, defining, or determining the behavior features, the program analysis module 208 allows the mobile device 102 to better adapt to changing conditions and/or better focus its monitoring and analysis operations on the precise combination of features that are most important to identifying and responding to non-benign behaviors. This may improve the performance, efficiency, and functioning of the mobile device 102.

In various aspects, the behavior observer module 202 may be configured to monitor the activities of the mobile computing device 102 by collecting information pertaining to library application programming interface (API) calls in an application framework or run-time libraries, system call APIs, file-system and networking sub-system operations, device (including sensor devices) state changes, and other similar events. In addition, the behavior observer module 202 may monitor file system activity, which may include searching for filenames, categories of file accesses (personal info or normal data files), creating or deleting files (e.g., type exe, zip, etc.), file read/write/seek operations, changing file permissions, etc.

The behavior observer module 202 may also monitor the activities of the mobile computing device 102 by monitoring data network activity, which may include types of connections, protocols, port numbers, server/client that the device is connected to, the number of connections, volume or frequency of communications, etc. The behavior observer module 202 may monitor phone network activity, which may include monitoring the type and number of calls or messages (e.g., SMS, etc.) sent out, received, or intercepted (e.g., the number of premium calls placed).

The behavior observer module 202 may also monitor the activities of the mobile computing device 102 by monitoring the system resource usage, which may include monitoring the number of forks, memory access operations, number of files open, etc. The behavior observer module 202 may monitor the state of the mobile computing device 102, which may include monitoring various factors, such as whether the display is on or off, whether the device is locked or unlocked, the amount of battery remaining, the state of the camera, etc. The behavior observer module 202 may also monitor inter-process communications (IPC) by, for example, monitoring intents to crucial services (browser, contracts provider, etc.), the degree of inter-process communications, pop-up windows, etc.

The behavior observer module 202 may also monitor the activities of the mobile computing device 102 by monitoring driver statistics and/or the status of one or more hardware components, which may include cameras, sensors, electronic displays, WiFi communication components, data controllers, memory controllers, system controllers, access ports, timers, peripheral devices, wireless communication components, external memory chips, voltage regulators, oscillators, phase-locked loops, peripheral bridges, and other similar components used to support the processors and clients running on the mobile computing device 102.

The behavior observer module 202 may also monitor the activities of the mobile computing device 102 by monitoring one or more hardware counters that denote the state or status of the mobile computing device 102 and/or computing device sub-systems. A hardware counter may include a special-purpose register of the processors/cores that is configured to store a count value or state of hardware-related activities or events occurring in the mobile computing device 102.

The behavior observer module 202 may also monitor the activities of the mobile computing device 102 by monitoring the actions or operations of software applications, software downloads from an application download server (e.g., Apple® App Store server), computing device information used by software applications, call information, text messaging information (e.g., SendSMS, BlockSMS, ReadSMS, etc.), media messaging information (e.g., ReceiveMMS), user account information, location information, camera information, accelerometer information, browser information, content of browser-based communications, content of voice-based communications, short range radio communications (e.g., Bluetooth, WiFi, etc.), content of text-based communications, content of recorded audio files, phonebook or contact information, contacts lists, etc.

The behavior observer module 202 may also monitor the activities of the mobile computing device 102 by monitoring transmissions or communications of the mobile computing device 102, including communications that include voicemail (VoiceMailComm), device identifiers (DevicelDComm), user account information (UserAccountComm), calendar information (CalendarComm), location information (LocationComm), recorded audio information (RecordAudioComm), accelerometer information (AccelerometerComm), etc.

The behavior observer module 202 may also monitor the activities of the mobile computing device 102 by monitoring the usage of, and updates/changes to, compass information, computing device settings, battery life, gyroscope information, pressure sensors, magnet sensors, screen activity, etc. The behavior observer module 202 may monitor notifications communicated to and from a software application (AppNotifications), application updates, etc. The behavior observer module 202 may monitor conditions or events pertaining to a first software application requesting the downloading and/or install of a second software application. The behavior observer module 202 may monitor conditions or events pertaining to user verification, such as the entry of a password, etc.

The behavior observer module 202 may also monitor the activities of the mobile computing device 102 by monitoring conditions or events at multiple levels of the mobile computing device 102, including the application level, radio level, and sensor level. Application level observations may include observing the user via facial recognition software, observing social streams, observing notes entered by the user, observing events pertaining to the use of PassBook®, Google® Wallet, Paypal®, and other similar applications or services. Application level observations may also include observing events relating to the use of virtual private networks (VPNs) and events pertaining to synchronization, voice searches, voice control (e.g., lock/unlock a phone by saying one word), language translators, the offloading of data for computations, video streaming, camera usage without user activity, microphone usage without user activity, etc.

Radio level observations may include determining the presence, existence or amount of any or more of user interaction with the mobile computing device 102 before establishing radio communication links or transmitting information, dual/multiple subscriber identification module (SIM) cards, Internet radio, mobile phone tethering, offloading data for computations, device state communications, the use as a game controller or home controller, vehicle communications, computing device synchronization, etc. Radio level observations may also include monitoring the use of radios (WiFi, WiMax, Bluetooth, etc.) for positioning, peer-to-peer (p2p) communications, synchronization, vehicle to vehicle communications, and/or machine-to-machine (m2m). Radio level observations may further include monitoring network traffic usage, statistics, or profiles.

Sensor level observations may include monitoring a magnet sensor or other sensor to determine the usage and/or external environment of the mobile computing device 102. For example, the computing device processor may be configured to determine whether the device is in a holster (e.g., via a magnet sensor configured to sense a magnet within the holster) or in the user's pocket (e.g., via the amount of light detected by a camera or light sensor). Detecting that the mobile computing device 102 is in a holster may be relevant to recognizing suspicious behaviors, for example, because activities and functions related to active usage by a user (e.g., taking photographs or videos, sending messages, conducting a voice call, recording sounds, etc.) occurring while the mobile computing device 102 is holstered could be signs of nefarious processes executing on the device (e.g., to track or spy on the user).

Other examples of sensor level observations related to usage or external environments may include, detecting near field communication (NFC) signaling, collecting information from a credit card scanner, barcode scanner, or mobile tag reader, detecting the presence of a Universal Serial Bus (USB) power charging source, detecting that a keyboard or auxiliary device has been coupled to the mobile computing device 102, detecting that the mobile computing device 102 has been coupled to another computing device (e.g., via USB, etc.), determining whether an LED, flash, flashlight, or light source has been modified or disabled (e.g., maliciously disabling an emergency signaling app, etc.), detecting that a speaker or microphone has been turned on or powered, detecting a charging or power event, detecting that the mobile computing device 102 is being used as a game controller, etc. Sensor level observations may also include collecting information from medical or healthcare sensors or from scanning the user's body, collecting information from an external sensor plugged into the USB/audio jack, collecting information from a tactile or haptic sensor (e.g., via a vibrator interface, etc.), collecting information pertaining to the thermal state of the mobile computing device 102, etc.

To reduce the number of factors monitored to a manageable level, in an aspect, the behavior observer module 202 may be configured to perform coarse observations by monitoring/observing an initial set of behaviors or factors that are a small subset of all factors that could contribute to the computing device's degradation. In an aspect, the behavior observer module 202 may receive the initial set of behaviors and/or factors from a server and/or a component in a cloud service or network. In an aspect, the initial set of behaviors/factors may be specified in machine learning classifier models.

Each classifier model may be a behavior model that includes data and/or information structures (e.g., feature vectors, behavior vectors, component lists, etc.) that may be used by a computing device processor to evaluate a specific feature or aspect of a computing device's behavior. Each classifier model may also include decision criteria for monitoring a number of features, factors, data points, entries, APIs, states, conditions, behaviors, applications, processes, operations, components, etc. (herein collectively “features”) in the computing device. The classifier models may be preinstalled on the computing device, downloaded or received from a network server, generated in the computing device, or any combination thereof. The classifier models may be generated by using crowd sourcing solutions, behavior modeling techniques, machine learning algorithms, etc.

Each classifier model may be categorized as a full classifier model or a lean classifier model. A full classifier model may be a robust data model that is generated as a function of a large training dataset, which may include thousands of features and billions of entries. A lean classifier model may be a more focused data model that is generated from a reduced dataset that includes/tests only the features/entries that are most relevant for determining whether a particular activity is an ongoing critical activity and/or whether a particular computing device behavior is not benign. As an example, a device processor may be may be configured to receive a full classifier model from a network server, generate a lean classifier model in the computing device based on the full classifier, and use the locally generated lean classifier model to classify a behavior of the device as being either benign or non-benign (i.e., malicious, performance degrading, etc.).

A locally generated lean classifier model is a lean classifier model that is generated in the computing device. That is, since modern computing devices (e.g., mobile devices, etc.) are highly configurable and complex systems, the features that are most important for determining whether a particular device behavior is non-benign (e.g., malicious or performance-degrading) may be different in each device. Further, a different combination of features may require monitoring and/or analysis in each device in order for that device to quickly and efficiently determine whether a particular behavior is non-benign. Yet, the precise combination of features that require monitoring and analysis, and the relative priority or importance of each feature or feature combination, can often only be determined using information obtained from the specific device in which the behavior is to be monitored or analyzed. For these and other reasons, various aspects may generate classifier models in the computing device in which the models are used. These local classifier models allow the device processor to accurately identify the specific features that are most important in determining whether a behavior on that specific device is non-benign (e.g., contributing to that device's degradation in performance). The local classifier models also allow the device processor to prioritize the features that are tested or evaluated in accordance with their relative importance to classifying a behavior in that specific device.

A device-specific classifier model is a classifier model that includes a focused data model that includes/tests only computing device-specific features/entries that are determined to be most relevant to classifying an activity or behavior in a specific computing device. An application-specific classifier model is a classifier model that includes a focused data model that includes/tests only the features/entries that are most relevant for evaluating a particular software application. By dynamically generating application-specific classifier models locally in the computing device, the various aspects allow the device processor to focus its monitoring and analysis operations on a small number of features that are most important for determining whether the operations of a specific software application are contributing to an undesirable or performance degrading behavior of that device.

A multi-application classifier model may be a local classifier model that includes a focused data model that includes or prioritizes tests on the features/entries that are most relevant for determining whether the collective behavior of two or more specific software applications (or specific types of software applications) is non-benign. A multi-application classifier model may include an aggregated feature set and/or decision nodes that test/evaluate an aggregated set of features. The device processor may be configured to generate a multi-application classifier model by identifying the device features that are most relevant for identifying the relationships, interactions, and/or communications between two or more software applications operating on the computing device, identifying the test conditions that evaluate one of identified device features, determining the priority, importance, or success rates of the identified test conditions, prioritizing or ordering the identified test conditions in accordance with their importance or success rates, and generating the classifier model to include the identified test conditions so that they are ordered in accordance with their determined priorities, importance, or success rates. The device processor may also be configured to generate a multi-application classifier model by combining two or more application-specific classifier models.

In various aspects, the device processor may be configured to generate a multi-application classifier model in response to determine that two or more applications are colluding or working in concert or that applications should be analyzed together as a group. The device processor may be configured to generate a multi-application classifier model for each identified group or class of applications. However, analyzing every group may consume a significant amount of the device's limited resources. Therefore, in an aspect, the device processor may be configured to determine the probability that an application is engaged in a collusive behavior (e.g., based on its interactions with the other applications, etc.), and intelligently generate the classifier models for only the groups that include software applications for which there is a high probability of collusive behavior.

The behavior analyzer module 206 may be configured to apply the behavior vectors generated by the behavior extractor module 204 to a classifier model to determine whether a monitored activity (or behavior) is benign or non-benign. In an aspect, the behavior analyzer module 206 may classify a behavior as “suspicious” when the results of its behavioral analysis operations do not provide sufficient information to classify the behavior as either benign or non-benign.

The behavior analyzer module 206 may be configured to notify the behavior observer module 202 in response to identifying the colluding software applications, determining that certain applications should be evaluated as a group, and/or in response to determining that a monitored activity or behavior is suspicious. In response, the behavior observer module 202 may adjust the granularity of its observations (i.e., the level of detail at which computing device features are monitored) and/or change the applications/factors/behaviors that are monitored based on information received from the behavior analyzer module 206 (e.g., results of the real-time analysis operations), generate or collect new or additional behavior information, and send the new/additional information to the behavior analyzer module 206 for further analysis/classification.

Such feedback communications between the behavior observer module 202 and the behavior analyzer module 206 enable the mobile computing device 102 to recursively increase the granularity of the observations (i.e., make finer or more detailed observations) or change the features/behaviors that are observed until a collective behavior is classified as benign or non-benign, a source of a suspicious or performance-degrading behavior is identified, until a processing or battery consumption threshold is reached, or until the device processor determines that the source of the suspicious or performance-degrading device behavior cannot be identified from further changes, adjustments, or increases in observation granularity. Such feedback communication also enable the mobile computing device 102 to adjust or modify the behavior vectors and classifier models without consuming an excessive amount of the computing device's processing, memory, or energy resources.

The behavior observer module 202 and the behavior analyzer module 206 may provide, either individually or collectively, real-time behavior analysis of the computing system's behaviors to identify suspicious behavior from limited and coarse observations, to dynamically determine behaviors to observe in greater detail, and to dynamically determine the level of detail required for the observations. This allows the mobile computing device 102 to efficiently identify and prevent problems without requiring a large amount of processor, memory, or battery resources on the device.

In various aspects, the device processor of the mobile computing device 102 may be configured to identify a critical data resource that requires close monitoring, monitor (e.g., via the behavior observer module 202) API calls made by software applications when accessing the critical data resource, identify a pattern of API calls as being indicative of non-benign behavior by two or more software applications, generate a behavior vector based on the identified pattern of API calls and resource usage, use the behavior vector to perform behavior analysis operations (e.g., via the behavior analyzer module 206), and determine whether one or more of the software application is non-benign based on the behavior analysis operations.

In an aspect, the device processor may be configured to identify APIs that are used most frequently by software applications operating on the computing device, store information regarding usage of identified hot APIs in an API log in a memory of the device, and perform behavior analysis operations based on the information stored in the API log to identify a non-benign behavior.

In the various aspects, the mobile computing device 102 may be configured to work in conjunction with a network server to intelligently and efficiently identify the features, factors, and data points that are most relevant to determining whether an activity or behavior is non-benign. For example, the device processor may be configured to receive a full classifier model from the network server, and use the received full classifier model to generate lean classifier models (i.e., data/behavior models) that are specific for the features and functionalities of the computing device or the software applications operating on the device. The device processor may use the full classifier model to generate a family of lean classifier models of varying levels of complexity (or “leanness”). The leanest family of lean classifier models (i.e., the lean classifier model based on the fewest number of test conditions) may be applied routinely until a behavior is encountered that the model cannot categorize as either benign or not benign (and therefore is categorized by the model as suspicious), at which time a more robust (i.e., less lean) lean classifier model may be applied in an attempt to categorize the behavior. The application of ever more robust lean classifier models within the family of generated lean classifier models may be applied until a definitive classification of the behavior is achieved. In this manner, the device processor can strike a balance between efficiency and accuracy by limiting the use of the most complete, but resource-intensive lean classifier models to those situations where a robust classifier model is needed to definitively classify a behavior.

In various aspects, the device processor may be configured to generate lean classifier models by converting a finite state machine representation/expression included in a full classifier model into boosted decision stumps. The device processor may prune or cull the full set of boosted decision stumps based on device-specific features, conditions, or configurations to generate a classifier model that includes a subset of boosted decision stumps included in the full classifier model. The device processor may then use the lean classifier model to intelligently monitor, analyze and/or classify a computing device behavior.

Boosted decision stumps are one level decision trees that have exactly one node (and thus one test question or test condition) and a weight value, and thus are well suited for use in a binary classification of data/behaviors. That is, applying a behavior vector to boosted decision stump results in a binary answer (e.g., Yes or No). For example, if the question/condition tested by a boosted decision stump is “is the frequency of Short Message Service (SMS) transmissions less than x per minute,” applying a value of “3” to the boosted decision stump will result in either a “yes” answer (for “less than 3” SMS transmissions) or a “no” answer (for “3 or more” SMS transmissions).

Boosted decision stumps are efficient because they are very simple and primal (and thus do not require significant processing resources). Boosted decision stumps are also very parallelizable, and thus many stumps may be applied or tested in parallel/at the same time (e.g., by multiple cores or processors in the computing device).

In an aspect, the device processor may be configured to generate a lean classifier model that includes a subset of classifier criteria included in the full classifier model and only those classifier criteria corresponding to the features relevant to the computing device configuration, functionality, and connected/included hardware. The device processor may use this lean classifier model(s) to monitor only those features and functions present or relevant to the device. The device processor may then periodically modify or regenerate the lean classifier model(s) to include or remove various features and corresponding classifier criteria based on the computing device's current state and configuration.

As an example, the device processor may be configured to receive a large boosted-decision-stumps classifier model that includes decision stumps associated with a full feature set of behavior models (e.g., classifiers), and derive one or more lean classifier models from the large classifier models by selecting only features from the large classifier model(s) that are relevant the computing device's current configuration, functionality, operating state and/or connected/included hardware, and including in the lean classifier model a subset of boosted decision stumps that correspond to the selected features. In this aspect, the classifier criteria corresponding to features relevant to the computing device may be those boosted decision stumps included in the large classifier model that test at least one of the selected features. The device processor may then periodically modify or regenerate the boosted decision stumps lean classifier model(s) to include or remove various features based on the computing device's current state and configuration so that the lean classifier model continues to include application-specific or device-specific feature boosted decision stumps.

In addition, the device processor may also dynamically generate application-specific classifier models that identify conditions or features that are relevant to specific software applications (Google® wallet and eTrade®) and/or to a specific type of software application (e.g., games, navigation, financial, news, productivity, etc.). These classifier models may be generated to include a reduced and more focused subset of the decision nodes that are included in the full classifier model (or of those included in a leaner classifier model generated from the received full classifier model). These classifier models may be combined to generate multi-application classifier models.

In various aspects, the device processor may be configured to generate application-based classifier models for each software application in the system and/or for each type of software application in the system. The device processor may also be configured to dynamically identify the software applications and/or application types that are a high risk or susceptible to abuse (e.g., financial applications, point-of-sale applications, biometric sensor applications, etc.), and generate application-based classifier models for only the software applications and/or application types that are identified as being high risk or susceptible to abuse. In various aspects, device processor may be configured to generate the application-based classifier models dynamically, reactively, proactively, and/or every time a new application is installed or updated.

Each software application generally performs a number of tasks or activities on the computing device. The specific execution state in which certain tasks/activities are performed in the computing device may be a strong indicator of whether a behavior or activity merits additional or closer scrutiny, monitoring and/or analysis. As such, in the various aspects, the device processor may be configured to use information identifying the actual execution states in which certain tasks/activities are performed to focus its behavioral monitoring and analysis operations, and better determine whether an activity is a critical activity and/or whether the activity is non-benign.

In various aspects, the device processor may be configured to associate the activities/tasks performed by a software application with the execution states in which those activities/tasks were performed. For example, the device processor may be configured to generate a behavior vector that includes the behavior information collected from monitoring the instrumented components in a sub-vector or data-structure that lists the features, activities, or operations of the software for which the execution state is relevant (e.g., location access, SMS read operations, sensor access, etc.). In an aspect, this sub-vector/data-structure may be stored in association with a shadow feature value sub-vector/data-structure that identifies the execution state in which each feature/activity/operation was observed. As an example, the device processor may generate a behavior vector that includes a “location background” data field whose value identifies the number or rate that the software application accessed location information when it was operating in a background state. This allows the device processor to analyze this execution state information independent of and/or in parallel with the other observed/monitored activities of the computing device. Generating the behavior vector in this manner also allows the system to aggregate information (e.g., frequency or rate) over time.

In various aspects, the device processor may be configured to generate the behavior vectors to include information that may be input to a decision node in the machine learning classifier to generate an answer to a query regarding the monitored activity.

In various aspects, the device processor may be configured to generate the behavior vectors to include execution information. The execution information may be included in the behavior vector as part of a behavior (e.g., camera used 5 times in 3 second by a background process, camera used 3 times in 3 second by a foreground process, etc.) or as part of an independent feature. In an aspect, the execution state information may be included in the behavior vector as a shadow feature value sub-vector or data structure. In an aspect, the behavior vector may store the shadow feature value sub-vector/data structure in association with the features, activities, or tasks for which the execution state is relevant.

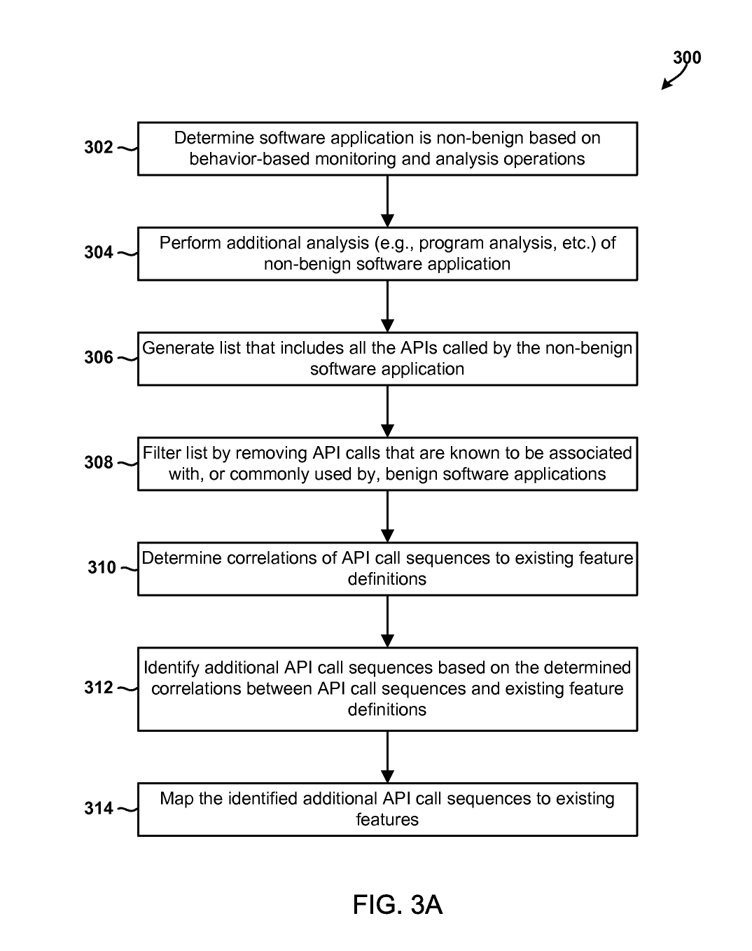

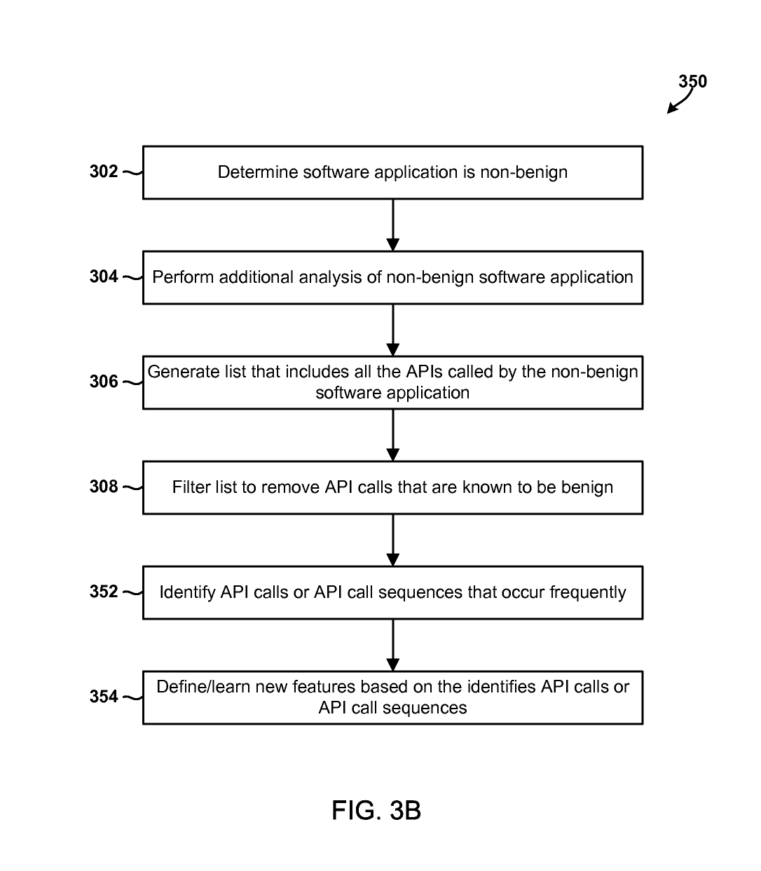

FIG. 3A illustrate a method 300 of updating or enhancing existing behavior features in accordance with an aspect. Method 300 may be performed by a processor or processing core in a mobile or resource-constrained computing device. In block 302, the processor may perform behavior-based monitoring and analysis operations, such as any or all of the operations discussed above with reference to FIG. 2, and determine that a software application is non-benign based on the behavior-based monitoring and analysis operations. For example, in block 302, the processor may monitor the activities of a software application operating on the computing device, generate a behavior vector information structure that characterizes monitored activities of the software application, apply the generated behavior vector information structure to machine-learning classifier model to generate analysis results, use the analysis results to classify the behavior vector information structure as benign or non-benign.

In block 304, the processor may perform additional analysis operations, such as program-based analysis operations, to identify the APIs called/invoked by the non-benign software application. In block 306, the processor may generate a list that includes the identified APIs. In block 308, the processor may filter the list by removing API calls (or API sequences) that are known to be benign, or which are associated with or commonly used by benign software applications. In block 310, the processor may identify API call sequences based on the APIs included in the filtered list, and determine or identify correlations between the API call sequences and existing feature definitions (e.g., behavior features included in behavior vectors, behavior features evaluated by classifier models, etc.). In block 312, the processor may identify additional API call sequences based on the correlations between the API call sequences and existing feature definitions. In block 314, the processor may map the identified additional API call sequences to existing features. For example, in block 314, the processor may update the API-to-feature mapping of behavior feature of a behavior vector that is used by the behavior-based monitoring and analysis system of the computing device.

FIG. 3B is a process flow diagram illustrating a method 350 of learning and generating new behavior features in accordance with an aspect. Method 350 may be performed by a processor or processing core in a mobile or resource-constrained computing device. In blocks 302-308, the processor may perform the operations discussed above with reference to FIG. 3A.

In block 352, the processor may identify API calls or API call sequences that occur frequently. In block 354, the processor may define/learn new features based on the identifies API calls or API call sequences. For example, in block 354, the processor may generate and add a new behavior feature to a behavior vector that is used by the behavior-based monitoring and analysis system of the computing device.

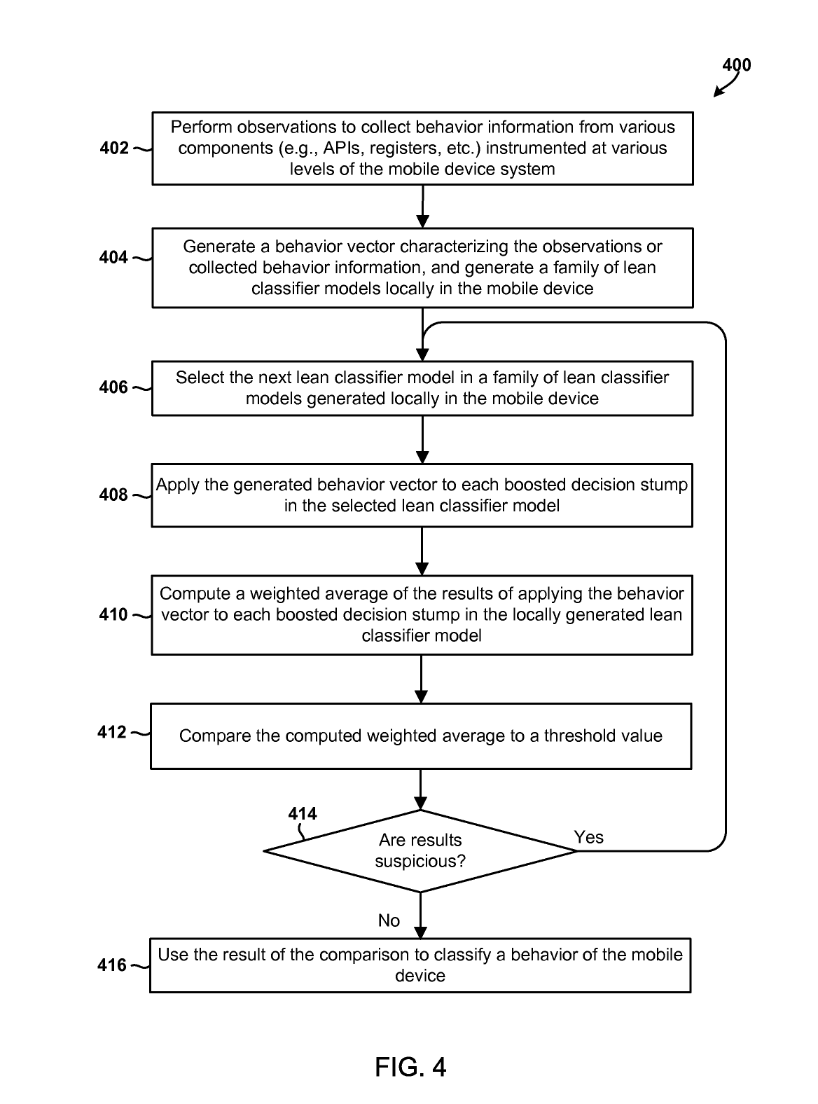

FIG. 4 illustrates an aspect method 400 of using a lean classifier model to classify a behavior of the computing device. In various aspects, method 400 may be performed as part of the lightweight analysis operations or as part of the robust analysis operations. In block 402, a processor or processing core of the computing device my perform observations to collect behavior information from various components that are instrumented at various levels of the device system. In an aspect, this may be accomplished via the behavior observer module 202 discussed above with reference to FIG. 2.

In block 404, the processing core may generate a behavior vector characterizing the observations, the collected behavior information, and/or a mobile device behavior. Also in block 404, the processing core may use a full classifier model received from a network server to generate a lean classifier model or a family of lean classifier models of varying levels of complexity (or “leanness”). In an aspect, the processing core may accomplish this by culling a family of boosted decision stumps included in the full classifier model to generate lean classifier models that include a reduced number of boosted decision stumps and/or evaluate a limited number of test conditions.

In block 406, the processing core may select the leanest classifier in the family of lean classifier models (i.e., the model based on the fewest number of different mobile device states, features, behaviors, or conditions) that has not yet been evaluated or applied by the mobile device. In an aspect, this may be accomplished by the processing core selecting the first classifier model in an ordered list of classifier models.

In block 408, the processing core may apply collected behavior information or behavior vectors to each boosted decision stump in the selected lean classifier model. Because boosted decision stumps are binary decisions and the lean classifier model is generated by selecting many binary decisions that are based on the same test condition, the process of applying a behavior vector to the boosted decision stumps in the lean classifier model may be performed in a parallel operation. Alternatively, the behavior vector may be truncated or filtered to just include the limited number of test condition parameters included in the lean classifier model, thereby further reducing the computational effort in applying the model.

In block 410, the processing core may compute or determine a weighted average of the results of applying the collected behavior information to each boosted decision stump in the lean classifier model. In block 412, the processing core may compare the computed weighted average to a threshold value. In determination block 414, the processing core may determine whether the results of this comparison and/or the results generated by applying the selected lean classifier model are suspicious. For example, the processing core may determine whether these results may be used to classify a behavior as either malicious or benign with a high degree of confidence, and if not treat the behavior as suspicious.

If the processing core determines that the results are suspicious (e.g., determination block 414=“Yes”), the processing core may repeat the operations in blocks 406-412 to select and apply a stronger (i.e., less lean) classifier model that evaluates more device states, features, behaviors, or conditions until the behavior is classified as malicious or benign with a high degree of confidence. If the processing core determines that the results are not suspicious (e.g., determination block 414=“No”), such as by determining that the behavior can be classified as either malicious or benign with a high degree of confidence, in block 416, the processing core may use the result of the comparison generated in block 412 to classify a behavior of the mobile device as benign or potentially malicious.

In an alternative aspect method, the operations described above may be accomplished by sequentially selecting a boosted decision stump that is not already in the lean classifier model; identifying all other boosted decision stumps that depend upon the same mobile device state, feature, behavior, or condition as the selected decision stump (and thus can be applied based upon one determination result); including in the lean classifier model the selected and all identified other boosted decision stumps that that depend upon the same mobile device state, feature, behavior, or condition; and repeating the process for a number of times equal to the determined number of test conditions. Because all boosted decision stumps that depend on the same test condition as the selected boosted decision stump are added to the lean classifier model each time, limiting the number of times this process is performed will limit the number of test conditions included in the lean classifier model.

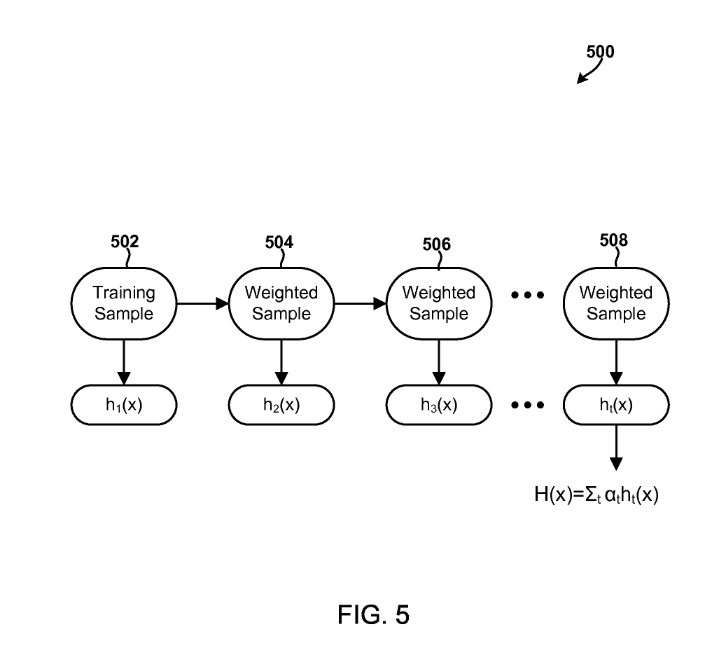

FIG. 5 illustrates an example boosting method 500 suitable for generating a boosted decision tree/classifier that is suitable for use in accordance with various aspects. In operation 502, a processor may generate and/or execute a decision tree/classifier, collect a training sample from the execution of the decision tree/classifier, and generate a new classifier model (h1(x)) based on the training sample. The training sample may include information collected from previous observations or analysis of mobile device behaviors, software applications, or processes in the mobile device. The training sample and/or new classifier model (h1(x)) may be generated based the types of question or test conditions included in previous classifiers and/or based on accuracy or performance characteristics collected from the execution/application of previous data/behavior models or classifiers of a behavior analyzer module 206. In operation 504, the processor may boost (or increase) the weight of the entries that were misclassified by the generated decision tree/classifier (h1(x)) to generate a second new tree/classifier (h2(x)). In an aspect, the training sample and/or new classifier model (h2(x)) may be generated based on the mistake rate of a previous execution or use (h1(x)) of a classifier. In an aspect, the training sample and/or new classifier model (h2(x)) may be generated based on attributes determined to have that contributed to the mistake rate or the misclassification of data points in the previous execution or use of a classifier.

In an aspect, the misclassified entries may be weighted based on their relatively accuracy or effectiveness. In operation 506, the processor may boost (or increase) the weight of the entries that were misclassified by the generated second tree/classifier (h2(x)) to generate a third new tree/classifier (h3(x)). In operation 508, the operations of 504-506 may be repeated to generate “t” number of new tree/classifiers (hₜ(x)).

By boosting or increasing the weight of the entries that were misclassified by the first decision tree/classifier (h1(x)), the second tree/classifier (h2(x)) may more accurately classify the entities that were misclassified by the first decision tree/classifier (h1(x)), but may also misclassify some of the entities that where correctly classified by the first decision tree/classifier (h1(x)). Similarly, the third tree/classifier (h3(x)) may more accurately classify the entities that were misclassified by the second decision tree/classifier (h2(x)) and misclassify some of the entities that where correctly classified by the second decision tree/classifier (h2(x)). That is, generating the family of tree/classifiers h1(x)-hₜ(x) may not result in a system that converges as a whole, but results in a number of decision trees/classifiers that may be executed in parallel.

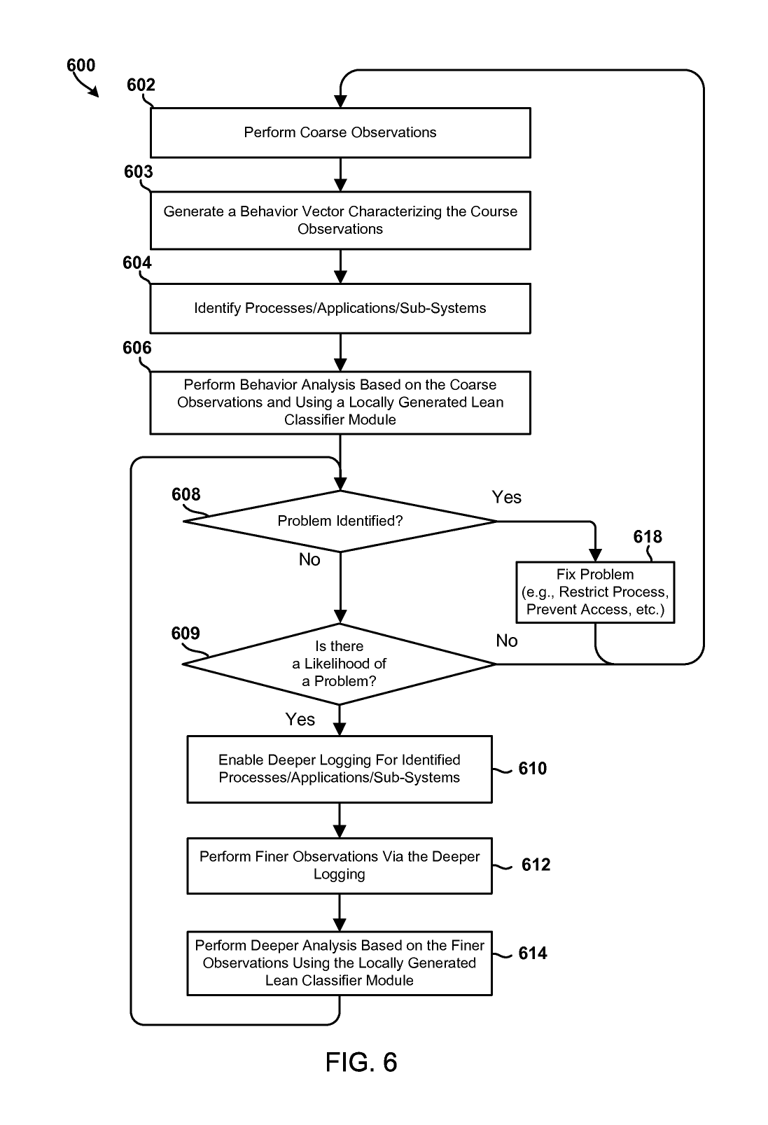

FIG. 6 illustrates an example method 600 for performing dynamic and adaptive observations in accordance with an aspect. In various aspects, method 600 may be performed as part of the lightweight analysis operations or as part of the robust analysis operations. In block 602, the mobile device processor (or processing core) may perform coarse observations by monitoring/observing a subset of a large number factors/behaviors that could contribute to the mobile device's degradation. In block 603, the mobile device processor may generate a behavior vector characterizing the coarse observations and/or the mobile device behavior based on the coarse observations. In block 604, the mobile device processor may identify subsystems, processes, and/or applications associated with the coarse observations that may potentially contribute to the mobile device's degradation. This may be achieved, for example, by comparing information received from multiple sources with contextual information received from sensors of the mobile device. In block 606, the mobile device processor may perform behavioral analysis operations based on the coarse observations. In an aspect, as part of blocks 603 and 604, the mobile device processor may perform one or more of the operations discussed above with reference to FIGS. 2-5.

In determination block 608, the mobile device processor may determine whether suspicious behaviors or potential problems can be identified and corrected based on the results of the behavioral analysis. When the mobile device processor determines that the suspicious behaviors or potential problems can be identified and corrected based on the results of the behavioral analysis (i.e., determination block 608=“Yes”), in block 618, the processor may initiate a process to correct the behavior and return to block 602 to perform additional coarse observations.

When the mobile device processor determines that the suspicious behaviors or potential problems cannot be identified and/or corrected based on the results of the behavioral analysis (i.e., determination block 608=“No”), in determination block 609 the mobile device processor may determine whether there is a likelihood of a problem. In an aspect, the mobile device processor may determine that there is a likelihood of a problem by computing a probability of the mobile device encountering potential problems and/or engaging in suspicious behaviors, and determining whether the computed probability is greater than a predetermined threshold. When the mobile device processor determines that the computed probability is not greater than the predetermined threshold and/or there is not a likelihood that suspicious behaviors or potential problems exist and/or are detectable (i.e., determination block 609=“No”), the processor may return to block 602 to perform additional coarse observations.

When the mobile device processor determines that there is a likelihood that suspicious behaviors or potential problems exist and/or are detectable (i.e., determination block 609=“Yes”), in block 610, the mobile device processor may perform more robust analysis operations that include performing deeper logging/observations or final logging on the identified subsystems, processes or applications. In block 612, the mobile device processor may perform deeper and more detailed observations on the identified subsystems, processes or applications. In block 614, the mobile device processor may perform further and/or deeper behavioral analysis based on the deeper and more detailed observations. In determination block 608, the mobile device processor may again determine whether the suspicious behaviors or potential problems can be identified and corrected based on the results of the deeper behavioral analysis. When the mobile device processor determines that the suspicious behaviors or potential problems cannot be identified and corrected based on the results of the deeper behavioral analysis (i.e., determination block 608=“No”), the processor may repeat the operations in blocks 610-614 until the level of detail is fine enough to identify the problem or until it is determined that the problem cannot be identified with additional detail or that no problem exists.

When the mobile device processor determines that the suspicious behaviors or potential problems can be identified and corrected based on the results of the deeper behavioral analysis (i.e., determination block 608=“Yes”), in block 618, the mobile device processor may perform operations to correct the problem/behavior, and the processor may return to block 602 to perform additional operations.

In an aspect, as part of blocks 602-618 of method 600, the mobile device processor may perform real-time behavior analysis of the system's behaviors to identify suspicious behaviors from limited and coarse observations, to dynamically determine the behaviors to observe in greater detail, and to dynamically determine the precise level of detail required for the observations. This enables the mobile device processor to efficiently identify and prevent problems from occurring, without requiring the use of a large amount of processor, memory, or battery resources on the device.

Generally, the performance and power efficiency of a mobile device degrade over time. Recently, anti-virus companies (e.g., McAfee, Symantec, etc.) have begun marketing mobile anti-virus, firewall, and encryption products that aim to slow this degradation. However, many of these solutions rely on the periodic execution of a computationally intensive scanning engine (or performing a full scan) on the mobile device, which may consume many of the mobile device's processing and battery resources, slow or render the mobile device useless for extended periods of time, and/or otherwise degrade the user experience. In addition, these solutions are typically limited to detecting known viruses and malware, and do not address the multiple complex factors and/or the interactions that often combine to contribute to a mobile device's degradation over time (e.g., when the performance degradation is not caused by viruses or malware). For these and other reasons, existing anti-virus, firewall, and encryption products do not provide adequate solutions for identifying the numerous factors that may contribute to a mobile device's degradation over time, for preventing mobile device degradation, or for efficiently restoring an aging mobile device to its original condition.

Mobile devices are resource constrained systems that have relatively limited processing, memory, and energy resources. Modern mobile devices are also complex systems, and there are a large variety of factors that may contribute to the degradation in performance and power utilization levels of a mobile device over time, including poorly designed software applications, malware, viruses, fragmented memory, background processes, etc. Due to the number, variety, and complexity of these factors, it is often not feasible to evaluate all the factors that may contribute to the degradation in performance and/or power utilization levels of the complex yet resource-constrained systems of modern mobile devices.

To overcome the limitations of existing solutions, the various aspects equip mobile devices with a behavioral monitoring and analysis system that configured to use machine learning and behavior-based techniques to quickly and efficiently identify non-benign software applications (e.g., applications that are malicious, poorly written, incompatible with the device, etc.), and prevent such applications from degrading the a computing device's performance, power utilization levels, network usage levels, security, and/or privacy over time. The behavioral monitoring and analysis system may be configured to identify, prevent, and correct identified problems without having a significant, negative, or user perceivable impact on the responsiveness, performance, or power consumption characteristics of the computing device.

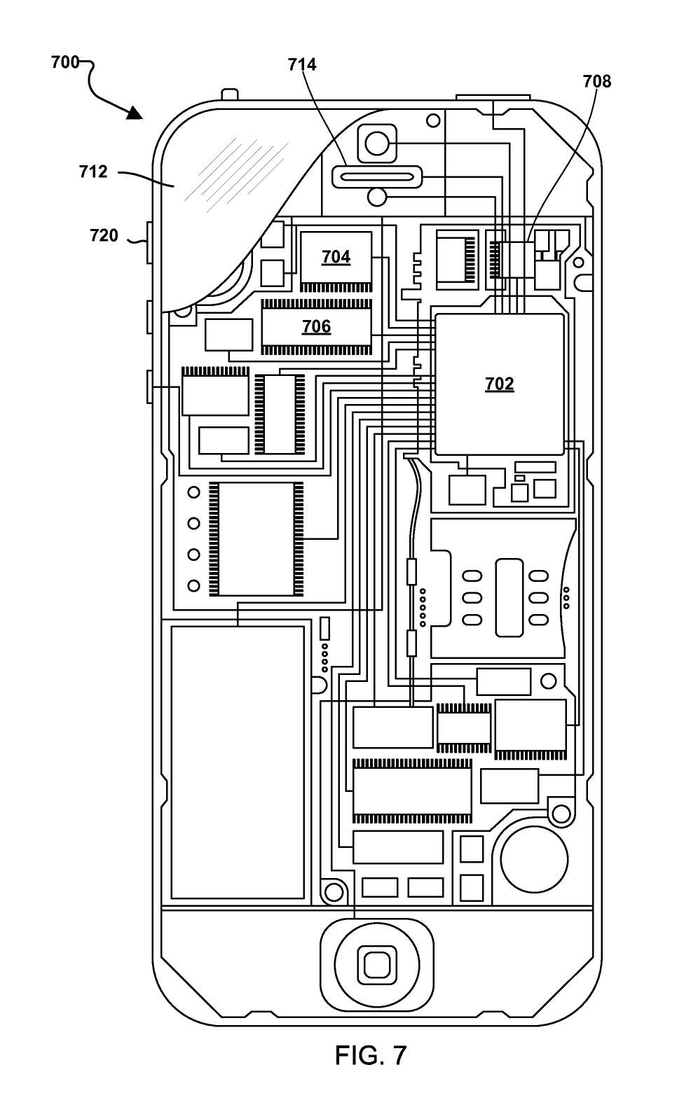

The various aspects may be implemented on a variety of computing devices, including mobile computing devices, an example of which is illustrated in FIG. 7 in the form of a smartphone. A smartphone 700 may include a processor 702 coupled to internal memory 704, a display 712, and to a speaker 714. Additionally, the smartphone 700 may include an antenna for sending and receiving electromagnetic radiation that may be connected to a wireless data link and/or cellular telephone transceiver 708 coupled to the processor 702. Smartphones 700 typically also include menu selection buttons or rocker switches 720 for receiving user inputs. A typical smartphone 700 also includes a sound encoding/decoding (CODEC) circuit 706, which digitizes sound received from a microphone into data packets suitable for wireless transmission and decodes received sound data packets to generate analog signals that are provided to the speaker to generate sound. Also, one or more of the processor 702, wireless transceiver 708 and CODEC 706 may include a digital signal processor (DSP) circuit (not shown separately).

The processors 702 may be any programmable microprocessor, microcomputer or multiple processor chip or chips that can be configured by software instructions (applications) to perform a variety of functions, including the functions of the various aspects described below. In some mobile devices, multiple processors 702 may be provided, such as one processor dedicated to wireless communication functions and one processor dedicated to running other applications. Typically, software applications may be stored in the internal memory 704 before they are accessed and loaded into the processor 702. The processor 702 may include internal memory sufficient to store the application software instructions.

The term “performance degradation” is used in this application to refer to a wide variety of undesirable operations and characteristics of a computing device, such as longer processing times, slower real time responsiveness, lower battery life, loss of private data, malicious economic activity (e.g., sending unauthorized premium SMS message), denial of service (DoS), poorly written or designed software applications, malicious software, malware, viruses, fragmented memory, operations relating to commandeering the computing device or utilizing the device for spying or botnet activities, etc. Also, behaviors, activities, and conditions that degrade performance for any of these reasons are referred to herein as “not benign” or “non-benign.”

Computer program code or “program code” for execution on a programmable processor for carrying out operations of the various aspects may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

Many mobile computing devices operating system kernels are organized into a user space (where non-privileged code runs) and a kernel space (where privileged code runs). This separation is of particular importance in Android® and other general public license (GPL) environments where code that is part of the kernel space must be GPL licensed, while code running in the user-space may not be GPL licensed. It should be understood that the various software components/modules discussed here may be implemented in either the kernel space or the user space, unless expressly stated otherwise.

The foregoing method descriptions and the process flow diagrams are provided merely as illustrative examples, and are not intended to require or imply that the operations of the various aspects must be performed in the order presented. As will be appreciated by one of skill in the art the order of operations in the foregoing aspects may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

As used in this application, the terms “component,” “module,” “system,” “engine,” “generator,” “manager,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution, and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

The various illustrative logical blocks, modules, circuits, and algorithm operations described in connection with the aspects disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a multiprocessor, but, in the alternative, the processor may be any conventional processor, controller, microcontroller, or state machine. A processor may also be implemented as a combination of computing devices, e.g., a combination of a DSP and a multiprocessor, a plurality of multiprocessors, one or more multiprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more processor-executable instructions or code on a non-transitory computer-readable storage medium or non-transitory processor-readable storage medium. The operations of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed aspects is provided to enable any person skilled in the art to make or use the claims. Various modifications to these aspects will be readily apparent to those skilled in the art, and the generic principles defined herein may be applied to other aspects without departing from the scope of the claims. Thus, the present invention is not intended to be limited to the aspects shown herein but is to be accorded the widest scope consistent with the following claims and the principles and novel features disclosed herein.

What is claimed is:

1. A method of analyzing behaviors of a computing device, comprising:
performing a behavior-based operation;
performing a program analysis operation in response to determining that a software application is non-benign based on the behavior-based operation; and
updating behavior features used to perform the behavior-based operation based on the program analysis operation.

2. The method of claim 1, wherein updating the behavior features used to perform the behavior-based operation based on the program analysis operation comprises generating a new behavior feature based on the program analysis operation.

3. The method of claim 1, wherein updating the behavior features used to perform the behavior-based operation based on the program analysis operation comprises updating an application programming interface (API)-to-feature mapping of an existing behavior feature based on the program analysis operation.

4. The method of claim 1, wherein performing the program analysis operation in response to determining that the software application is non-benign comprises:
identifying all application programming interface (API) calls that are associated with the software application;
generating a list that includes the identified API calls;
filtering the list to remove API calls that are associated with known benign applications; and
identifying API call sequences based on the API calls included in the filtered list.

5. The method of claim 4, wherein performing the program analysis operation in response to determining that the software application is non-benign further comprises:
identifying a correlation between an identified API call sequence and an existing behavior feature;
identifying an additional API call sequence based on the identified correlation; and
updating an API-to-feature mapping of the existing behavior feature to include the additional API call sequence.

6. The method of claim 4, wherein performing the program analysis operation in response to determining that the software application is non-benign further comprises:
determining whether any of the identified API call sequences occur frequently; and
generating a new behavior feature for each of the identified API call sequences that are determined to occur frequently.

7. The method of claim 1, wherein performing the behavior-based operation comprises:
monitoring activities of the software application operating on the computing device;
generating a behavior vector information structure that characterizes monitored activities of the software application;
applying the generated behavior vector information structure to machine-learning classifier model to generate analysis results; and
using the analysis results to classify the behavior vector information structure as non-benign.

8. The method of claim 7, wherein updating the behavior features used to perform the behavior-based operation based on the program analysis operation comprises updating a API-to-feature mapping of a behavior feature included in the behavior vector information structure based on a result of the program analysis operation.

9. The method of claim 7, wherein updating the behavior features used to perform the behavior-based operation based on the program analysis operation comprises updating a condition evaluated by a decision node in the machine-learning classifier model based on a result of the program analysis operation.

10. The method of claim 7, wherein updating the behavior features used to perform the behavior-based operation based on the program analysis operation comprises inserting a new behavior feature into the behavior vector information structure based on a result of the program analysis operation.

11. The method of claim 7, wherein updating the behavior features used to perform the behavior-based operation based on the program analysis operation comprises adding a new decision node to the machine-learning classifier model based on a result of the program analysis operation.

12. A computing device, comprising:
means for performing a behavior-based operation;
means for performing a program analysis operation in response to determining that a software application is non-benign based on the behavior-based operation; and
means for updating behavior features used to perform the behavior-based operation based on the program analysis operation.

13. The computing device of claim 12, wherein means for updating behavior features used to perform the behavior-based operation based on the program analysis operation comprises means for generating a new behavior feature or updating an application programming interface (API)-to-feature mapping of an existing behavior feature based on the program analysis operation.

14. The computing device of claim 12, wherein means for performing the program analysis operation in response to determining that the software application is non-benign comprises:
means for identifying all application programming interface (API) calls that are associated with the software application;
means for generating a list that includes the identified API calls;
means for filtering the list to remove API calls that are associated with known benign applications;
means for identifying API call sequences based on the API calls included in the filtered list;
means for identifying a correlation between an identified API call sequence and an existing behavior feature;
means for identifying an additional API call sequence based on the identified correlation; and
means for updating an API-to-feature mapping of the existing behavior feature to include the additional API call sequence.

15. The computing device of claim 12, wherein means for performing the program analysis operation in response to determining that the software application is non-benign comprises:
means for identifying all application programming interface (API) calls that are associated with the software application;
means for generating a list that includes the identified API calls;
means for filtering the list to remove API calls that are associated with known benign applications;
means for identifying API call sequences based on the API calls included in the filtered list;
means for determining whether any identified API call sequences occur frequently; and
means for generating a new behavior feature for each of the identified API call sequences that are determined to occur frequently.

16. The computing device of claim 12, wherein means for performing the behavior-based operation comprises:
means for monitoring activities of the software application as it operates on the computing device;
means for generating a behavior vector information structure that characterizes monitored activities of the software application;
means for applying the generated behavior vector information structure to machine-learning classifier model to generate analysis results; and
means for using the analysis results to classify the behavior vector information structure as non-benign.

17. The computing device of claim 12, wherein means for updating behavior features used to perform the behavior-based operation based on the program analysis operation comprises one of:
means for updating a API-to-feature mapping of a behavior feature included in a behavior vector information structure based on a result of the program analysis operation;
means for updating a condition evaluated by a decision node in a machine-learning classifier model based on the result of the program analysis operation;
means for inserting a new behavior feature into the behavior vector information structure based on the result of the program analysis operation; and
means for adding a new decision node to the machine-learning classifier model based on the result of the program analysis operation.

18. A computing device, comprising:
a processor configured with processor-executable instructions to perform operations comprising:
performing a behavior-based operation;
performing a program analysis operation in response to determining that a software application is non-benign based on the behavior-based operation; and
updating behavior features used to perform the behavior-based operation based on the program analysis operation.

19. The computing device of claim 18, wherein the processor is configured with processor-executable instructions to perform operations such that updating the behavior features used to perform the behavior-based operation based on the program analysis operation comprises generating a new behavior feature or updating an application programming interface (API)-to-feature mapping of an existing behavior feature based on the program analysis operation.

20. The computing device of claim 18, wherein the processor is configured with processor-executable instructions to perform operations such that performing the program analysis operation in response to determining that the software application is non-benign comprises:
identifying all application programming interface (API) calls that are associated with the software application;
generating a list that includes the identified API calls;
filtering the list to remove API calls that are associated with known benign applications;
identifying API call sequences based on the API calls included in the filtered list;
identifying a correlation between an identified API call sequence and an existing behavior feature;
identifying an additional API call sequence based on the identified correlation; and
updating an API-to-feature mapping of the existing behavior feature to include the additional API call sequence.

21. The computing device of claim 18, wherein the processor is configured with processor-executable instructions to perform operations such that performing the program analysis operation in response to determining that the software application is non-benign comprises:
identifying all application programming interface (API) calls that are associated with the software application;
generating a list that includes the identified API calls;
filtering the list to remove API calls that are associated with known benign applications;
identifying API call sequences based on the API calls included in the filtered list;
determining whether any of the identified API call sequences occur frequently; and
generating a new behavior feature for each of the identified API call sequences that are determined to occur frequently.

22. The computing device of claim 18, wherein the processor is configured with processor-executable instructions to perform operations such that performing the behavior-based operation comprises:
monitoring activities of the software application as it operates on the computing device;
generating a behavior vector information structure that characterizes monitored activities of the software application;
applying the generated behavior vector information structure to machine-learning classifier model to generate analysis results; and
using the analysis results to classify the behavior vector information structure as non-benign.

23. The computing device of claim 18, wherein the processor is configured with processor-executable instructions to perform operations such that updating the behavior features used to perform the behavior-based operation based on the program analysis operation comprises performing an update operation selected from the group consisting of:
updating a API-to-feature mapping of a behavior feature included in a behavior vector information structure based on a result of the program analysis operation;
updating a condition evaluated by a decision node in a machine-learning classifier model based on the result of the program analysis operation;
inserting a new behavior feature into the behavior vector information structure based on the result of the program analysis operation; and
adding a new decision node to the machine-learning classifier model based on the result of the program analysis operation.

24. A non-transitory computer readable storage medium having stored thereon processor-executable software instructions configured to cause a processor of a computing device to perform operations, comprising:
performing a behavior-based operation;
performing a program analysis operation in response to determining that a software application is non-benign based on the behavior-based operation; and
updating behavior features used to perform the behavior-based operation based on the program analysis operation.

25. The non-transitory computer readable storage medium of claim 24, wherein the stored processor-executable software instructions are configured to cause a processor to perform operations such that updating the behavior features used to perform the behavior-based operation based on the program analysis operation comprises generating a new behavior feature or updating an application programming interface (API)-to-feature mapping of an existing behavior feature based on the program analysis operation.

26. The non-transitory computer readable storage medium of claim 24, wherein the stored processor-executable software instructions are configured to cause a processor to perform operations such that performing the program analysis operation in response to determining that the software application is non-benign comprises:
identifying all application programming interface (API) calls that are associated with the software application;
generating a list that includes the identified API calls;
filtering the list to remove API calls that are associated with known benign applications; and
identifying API call sequences based on the API calls included in the filtered list.

27. The non-transitory computer readable storage medium of claim 26, wherein the stored processor-executable software instructions are configured to cause a processor to perform operations such that performing the program analysis operation in response to determining that the software application is non-benign further comprises:
identifying a correlation between an identified API call sequence and an existing behavior feature;
identifying an additional API call sequence based on the identified correlation; and
updating an API-to-feature mapping of the existing behavior feature to include the additional API call sequence.

28. The non-transitory computer readable storage medium of claim 26, wherein the stored processor-executable software instructions are configured to cause a processor to perform operations such that performing the program analysis operation in response to determining that the software application is non-benign further comprises:
determining whether any of the identified API call sequences occur frequently; and
generating a new behavior feature for each of the identified API call sequences that are determined to occur frequently.

29. The non-transitory computer readable storage medium of claim 24, wherein the stored processor-executable software instructions are configured to cause a processor to perform operations such that performing the behavior-based operation comprises:
monitoring activities of the software application as it operates on the computing device;
generating a behavior vector information structure that characterizes monitored activities of the software application;
applying the generated behavior vector information structure to machine-learning classifier model to generate analysis results; and
using the analysis results to classify the behavior vector information structure as non-benign.

30. The non-transitory computer readable storage medium of claim 24, wherein the stored processor-executable software instructions are configured to cause a processor to perform operations such that updating the behavior features used to perform the behavior-based operation based on the program analysis operation comprises performing an update operation selected from the group consisting of:
updating a API-to-feature mapping of a behavior feature included in a behavior vector information structure based on a result of the program analysis operation;
updating a condition evaluated by a decision node in a machine-learning classifier model based on the result of the program analysis operation;
inserting a new behavior feature into the behavior vector information structure based on the result of the program analysis operation; and
adding a new decision node to the machine-learning classifier model based on the result of the program analysis operation.
